(19) United States
(12) Patent Application Publication
(10) Pub. No.: US 2022/0333253 A1
(43) Pub. Date: Oct. 20, 2022

(54) Electrochemical preparation of vanadium electrolytes and sulfates of multivalent transition metals

(71) Applicant: Francois CARDARELLI, Montreal (CA)

(72) Inventor: Francois CARDARELLI, Montreal (CA)

(21) Appl. No.: 17/235,857

(22) Filed: Apr. 20, 2021

Related U.S. Application Data
(60) Provisional application No. 63/173,401, filed on Apr. 10, 2021.
(60) Provisional application No. 63/172,618, filed on Apr. 8, 2021.

(51) Int. Cl. C25B 1/01; C25B 11/046; C01G 31/00; C01G 49/14

(52) U.S. Cl. CPC C25B 1/01; C25B 11/046; C01G 31/006; C01G 49/14

(57) ABSTRACT

The present disclosure broadly relates to a process for preparing aqueous solutions of vanadium sulfates or aqueous solutions of transition metal sulfates. More specifically, but not exclusively, the present disclosure relates to a direct electrochemical process in which a suspension, obtained by slurrying transition metals oxides such as oxides of vanadium, oxides of iron, oxides of cobalt, oxides of nickel, oxides of chromium, oxides of manganese, oxides of titanium, oxides of cerium, oxides of praseodymium, oxides of europium, oxides of terbium, oxides of uranium, oxides of plutonium, or their mixtures thereof with sulfuric acid as carrier fluid, is reduced electrochemically inside the cathode compartment of an electrolyzer to produce an aqueous solution of vanadium sulfates or of transition metal sulfates. Simultaneously, oxidizing co-products are produced in the anode compartment.

### CROSS-REFERENCE TO RELATED APPLICATIONS

The present application claims the benefit of priority from U.S. provisional applications Nos. 63/172,618 and 63/173,401 filed on Apr. 8^{th}, 2021 and Apr. 10^{th}, 2021 respectively, the content of which are incorporated herein by reference in their entirety.

### FIELD OF THE INVENTION

The present disclosure broadly relates to a process for preparing aqueous solutions of vanadium sulfates or aqueous solutions of transition metal sulfates. More specifically, but not exclusively, the present disclosure relates to a direct electrochemical process in which a suspension, obtained by slurrying transition metals oxides such as oxides of vanadium, oxides of iron, oxides of cobalt, oxides of nickel, oxides of chromium, oxides of manganese, oxides of titanium, oxides of cerium, oxides of praseodymium, oxides of europium, oxides of terbium, oxides of uranium, oxides of plutonium, or their mixtures thereof with sulfuric acid as carrier fluid, is reduced electrochemically inside the cathode compartment of an electrolyzer to produce an aqueous solution of vanadium sulfates or of transition metal sulfates. Simultaneously, oxidizing co-products are produced in the anode compartment.

### BACKGROUND OF THE INVENTION

Since the pioneering work performed in 1976 at the National Aeronautics and Space Administration (NASA) by Lawrence H. Thaller (U.S. Pat. No. 3,996,064), who investigated various redox systems used for testing redox flow batteries (RFBs), these new types of power sources gained in importance over the years. Later, in 1986 with the pioneering work of Maria Skyllas-Kazacos et al. (U.S. Pat. No. 4,786,567), all vanadium redox flow batteries (VRFB) became the most widely adopted redox system from micro-grid installations up to grid scale energy storage with installations already in place in Europe, Asia and North America.

The VRFB's technology consists to an electrochemical stack comprising a divided electrolyzer with electrode and membranes with circulating electrolytes employing the V(II)/V(III) and V(IV)V(V) redox vanadium couples dissolved in sulfuric acid as the negative electrolyte or negalyte (i.e., solution in contact with the negative electrode or cathode) and positive electrolyte or posilyte (i.e., solution in contact with the positive electrode or anode). Most often, the equimolar vanadium electrolyte solution for preparing both the posilyte and the negalyte is made of an aqueous solution of vanadium (IV) and V(III) sulfates with an equimolar ratio (i.e., [VO²⁺]=[V³⁺]). On the other hand, the total molarity for vanadium as element [V(total)]=[VO²⁺]+[V³⁺] is fixed and usually ranges from 1.6M to 2.0M while the concentration of free sulfuric acid usually ranges between 2M and 3M. This means that the average oxidation number (no) or average valence of vanadium is simply given by the following equation: no={4[VO²⁺]+3[V³⁺]}/[V(total)] which is equal to +3.5 for true equimolar electrolytes. This vanadium electrolyte solution is then suited to be converted into posilyte and negalyte inside the anode and cathode compartments respectively by an electrolytic process performed by charging the VRFB battery until the posilyte contains essentially all the vanadium as V(V) cations and the negalyte as V(II) cations respectively.

Industrially, all vanadium sulfates electrolyte solutions are prepared chemically by reacting high purity vanadium pentoxide (V₂O₅) as starting material with high purity sulfuric acid (H₂SO₄). However, this chemical process requires the mandatory use of a reducing chemical that allows the reduction of the barely soluble peroxovanadium (VO₂⁺) cation into highly soluble vanadyl (VO²⁺) cation and in a lesser extend V(III) cation to reach the targeted molarities. The proper reducing agent used is either an organic compound such as oxalic acid or an inorganic reagent such as vanadium (III) oxide (V₂O₃), sulfur (S₈) or sulfur dioxide (SO₂).

Early in 1939, Holger H. Schaumann from DuPont de Nemours & Company (U.S. Pat. No. 2,289,462) devised an electrochemical process in which a suspension of vanadium pentoxide with sulfuric acid as carrier liquid was reduced inside the cathode compartment of a cylindrical electrolyzer to produce an aqueous solution of vanadyle sulfate. However, at that time the electrolyzer was solely equipped with an anode and cathode both made of lead and a porous porcelain diaphragm acting as separator. Moreover, the electrolysis has to be conducted at low cathode current density of 19 amperes per square foot (204 A/m²) with high cell voltages from 4.0 volts to 6.0 volts due to the resistance of the porous diaphragm and presumably from the high overvoltage for the oxygen gas evolution of the lead anode. The low cathode current density used at that time is not compatible today to sustain production rates required by an industrial scale operation for producing a vanadium electrolyte. The specific electric charge and energy consumption calculated as 293 Ah/kg and 1,550 Wh/kg of V₂O₅ respectively with a cathode current efficiency of 98.8 percent. More importantly, the process as described is only able to produce a solution of vanadyl sulfate. Actually, with the type of lead anode and the porous diaphragm it is extremely difficult to carry-on the electrolysis and to produce vanadium (III) species efficiently and in equilibrium with V(IV) due to the migration of vanadium cations across the non-selective porous diaphragm resulting in the rapid oxidation of V(III) into V(IV) and in lesser extent oxidation of V(IV) to V(V) with formation of V₂O₅ film onto the lead anode surface.

Fifty years later, in 1989, Maria Skyllas-Kazacos et al. devised an electrochemical process described in the PCT International Patent Application to Unisearch Limited (PCT Int. Patent Application WO 89/05363) that consisted of reducing electrochemically a suspension or slurry of vanadium pentoxide with an aqueous solution of sulfuric acid but containing already a reducing agent such as vanadium (III) sulfate or vanadium (II) sulfate in the catholyte. This process can be used in the laboratory to produce small volumes of vanadium electrolyte but becomes impractical at an industrial scale as it requires upfront the tedious and costly production of vanadium (II) and vanadium (III) compounds by a mean of chemical or metallurgical processes. The latter being mandatory to ensure the proper reduction of V(V) and its rapid dissolution.

In 2003, Tanaka et al. devised a chemical process utilized industrially by Sumitomo Electric Industries, Ltd. (U.S. Pat. No. 6,613,298 B2), during which vanadium pentoxide and/or vanadium dioxide solids are mixed with concentrated sulfuric acid and sulfur inside a kneader or pug mill, and the thick paste obtained, is baked at temperature ranging from 150° C. up to 440° C. Then, the reacted solid mass is dissolved in hot water to yield an aqueous solution containing both vanadyle and vanadium (III) sulfates with various molar ratios and unreacted sulfur particles depending on the initial mixture composition. Because the molar ratio of V(IV) and V(III) is difficult to achieve the crude solution requires a further processing either chemically or electrochemically to be converted into a pure equimolar vanadium electrolyte with additionally the adjustment of the concentration of free sulfuric acid. Such chemical process exhibits several drawbacks such as an elevate production costs, the tedious control of the process parameters, requires multiple steps, and it poses occupational health and safety issues especially when it comes to noxious emissions of sulfur dioxide.

On the other hand, other redox systems involving multivalent transition metals are considered as potential alternative to all vanadium sulfate electrolytes including the following redox couples: Fe(II)/Fe(III), Mn(II)/Mn(IV), Cr(II)/Cr(III), Ti(III)/Ti(IV), Ce(III)/Ce(IV), and even U(IV)/U(VI), and Pu(IV)/Pu(V) were suggested from spent nuclear wastes, were also investigated. This leads to the quest for new direct preparation methods with the requirements of ease of process control, high yields, cost affordability, health and safety of the work place, social acceptance, and without any adverse effects on the environment.

Actually, as for the vanadium sulfate electrolyte, the industrial processes for preparing aqueous solutions of multivalent transition metal sulfates relies on the chemical sulfation route that consists either to digest, to dissolve or to leach the corresponding transition metal oxides with sulfuric acid under a wide range of acid concentrations and operating conditions. Because for most commercially available raw materials or transition metal oxides, the metal cations from the transition metal oxides exhibit the highest or at least a higher oxidation state of the multivalent transition metal (e.g., V₂O₅, Fe₂O₃, CrO₃, Co₂O₃, MnO₂, TiO₂, CeO₂) with poor chemical reactivity towards sulfuric acid thus it requires both harsh operating conditions and to maintain reducing conditions to reach the complete dissolution such as elevate temperatures and/or pressure. As exemplified above, in the particular case of vanadium (V) oxide, without maintaining reducing conditions, the chemical dissolution by sulfation of the V(V) is very weak due to the poor solubility of the peroxovanadium (VO²⁺) cations. This inherent difficulty is also encountered with ferric oxide as hematite (α-Fe₂O₃) and manganese (IV) oxide (MnO₂) that both require the assistance of reducing conditions to yield highly soluble iron (II) or Mn (II) cations respectively.

On the other hand, in the above chemical processes the dissolution reaction kinetics is driven by temperature, the concentration of sulfuric acid, and that of the reducing agent that makes the production rate not easily adjustable especially with multivalent cations such as those of vanadium (e.g., +II, +III, +IV, +V), chromium (e.g., +II, +III, +VI) and manganese (e.g., +II, +III, +IV, +VII).

The present description refers to a number of documents, the content of which is herein incorporated by reference in their entirety.

### BRIEF SUMMARY OF THE INVENTION

The present disclosure broadly relates to a process for preparing aqueous solutions of vanadium sulfates or aqueous solutions of transition metal sulfates. More specifically, but not exclusively, the present disclosure relates to a direct electrochemical process in which a suspension, obtained by slurrying transition metals oxides such as oxides of vanadium, oxides of iron, oxides of cobalt, oxides of nickel, oxides of chromium, oxides of manganese, oxides of titanium, oxides of cerium, oxides of praseodymium, oxides of europium, oxides of terbium, oxides of uranium, oxides of plutonium, or their mixtures thereof with sulfuric acid as carrier fluid, is reduced electrochemically inside the cathode compartment of an electrolyzer to produce an aqueous solution of vanadium sulfates or of transition metal sulfates. Simultaneously oxidizing co-products are produced in the anode compartment.

In an aspect, the present disclosure relates to process for producing aqueous solutions of vanadium sulfates or aqueous solutions of transition metal sulfates from the corresponding transition metal oxides, the process comprising:
Preparing a suspension by mixing vanadium oxides or transition metal oxides with sulfuric acid as a carrier fluid; and
Reducing electrochemically the suspension of vanadium oxides or transition metal oxides by circulating the slurry inside the cathode compartment of an electrolyzer producing a solution of vanadium sulfates or a solution of the transition metal sulfates; and
Producing concurrently, inside the anode compartment, oxidizing co-products made of: sulfuric acid, oxygen gas, peroxodisulfuric acid, ammonium peroxodisulfate, ceric sulfate, manganese dioxide or another oxidizing inorganic product.

In an embodiment of the present disclosure, the transition metal oxides refer to metallic oxides materials containing multivalent transition metals, lanthanides and even actinides with the empirical chemical formula M₂Oₓ with x being an integer ranging from x equal to 1 to x equal to 7 and M a transition metal with M=Ti, V, Cr, Mn, Fe, Co, Ni, Ce, Pr, Eu, Tb, U, Np, Pu, such as for instance oxides of titanium, oxides of vanadium, oxides of chromium, oxides of manganese, oxides of iron, oxides of cobalt, oxides of nickel, oxides of cerium, oxides of europium, oxides of praseodymium, oxides of terbium, oxides of uranium and oxides of plutonium, in various oxidation states or a mixture thereof.

In a further embodiment, the present disclosure relates first to a process consisting to perform the mixing of the vanadium oxides or transition metal oxides with sulfuric acid as carrier fluid in order to obtain a suspension of the solids or slurry.

In an embodiment, the concentration of sulfuric acid used during this step and expressed in mass percentage ranges from 5 wt. % H₂SO₄ up to 98 wt. % H₂SO₄. In a further embodiment, the concentration of sulfuric acid expressed in mass percentage ranges from 10 wt. % H₂SO₄ up to 80 wt. % H₂SO₄. In a further embodiment, the concentration of sulfuric acid expressed in mass percentage ranges from 15 wt. % H₂SO₄ up to 60 wt. % H₂SO₄.

In a further embodiment of the present disclosure, the mass percentage of suspended solids or pulp density during this step ranges from 1 wt. % solids up to 80 wt. % solids. In a further embodiment, the pulp density ranges from 5 wt. % solids up to 70 wt. % solids. In a further embodiment, the pulp density ranges from 10 wt. % solids up to 60 wt. % solids.

In a further embodiment of the present disclosure the vanadium oxides or the transition metal oxides exhibit a particle size below 0.500 mm, in an embodiment below 0.125 mm, in a further embodiment lower than 0.050 mm.

In a further embodiment of the present disclosure, in order to maintain complete fluidization and transport of vanadium oxides or the transition metals oxides particles inside the cathode compartment, the linear velocity of the fluid inside the cathode compartment must be maintained at all time equal or above the terminal settling velocity calculated for the largest solid particles. In an embodiment, the dimensionless ratio of the linear fluid velocity, u_{f}, inside the cathode compartment to the terminal settling velocity, uₜ, denoted (u_{f}/uₜ), ranges between 1 and 100. In a further embodiment, the dimensionless ratio of the linear fluid velocity to the minimum fluidization velocity ranges between 2 and 50.

In a further embodiment of the present disclosure, in order to perform the proper hydraulic conveying of the suspension of vanadium oxides or transition metal oxides inside the piping circuit, the tubes and ducts, the fluid linear velocity inside the piping and tubing must be above the terminal settling velocity calculated for the largest solid particles. In an embodiment, the dimensionless ratio of the linear fluid velocity, u_{f}, to the terminal settling velocity, uₜ, denoted (u_{f}/uₜ), ranges between 2.0 and 10,000. In a further embodiment, the dimensionless ratio of the linear fluid velocity to the terminal settling velocity ranges between 5.0 and 5,000. In yet a further embodiment, the dimensionless ratio of the linear fluid velocity to the terminal settling velocity ranges between 50 and 2,500.

In a further embodiment of the present disclosure, if the initial wettability or rheology during mixing conditions must be adjusted, chemical additives and surfactants can be eventually added to the mixture in order to improve the mixing properties or stability of the suspended solid particles.

In yet a further embodiment of the present disclosure, the suspension of vanadium oxides or of the transition metal oxides obtained after slurrying with sulfuric acid, is reduced electrochemically by performing slurry electrolysis.

In yet a further embodiment of the present disclosure, the electrochemical reduction is performed using a divided electrolyzer. The suspension of vanadium oxides or transition metal oxides in sulfuric acid is the catholyte and it circulates inside the cathode compartment. The separator is either a diaphragm or an ion exchange membrane. The electrolyzer comprises an anode made of: titanium metal or its alloy coated with mixed metal oxides (MMO), niobium metal or its alloy coated with mixed metal oxides (MMO), tantalum metal or its alloy coated with mixed metal oxides (MMO), lead and its alloys, lead dioxide, or electrically conductive ceramics with the spinel structure with chemical formula A^{II}B^{III}₂O₄ where A=Fe²⁺, Co²⁺, Ni²⁺, Mg²⁺, Cu²⁺, and B=Fe³⁺, Al³⁺, Cr³⁺, Ti⁴⁺, V³⁺, such as cast magnetite or nonstoichiometric titanium oxides made of Magneli's phases (e.g., TiₙO₂ₙ₋₁).

The electrolyzer comprises a cathode made of: aluminum and its alloys, iron and its alloys, cobalt and its alloys, nickel and its alloys, copper and its alloys, cadmium and its alloys, lead or its alloys, zinc and its alloys, titanium and its alloys, zirconium and its alloys, hafnium and its alloys, niobium and its alloys, tantalum and its alloys, mercury and amalgams of mercury, graphite, or electrically conductive ceramics with the spinel structure with chemical formula A^{II}B^{III}₂O₄ where A=Fe²⁺, Co²⁺, Ni²⁺, Mg²⁺, Cu²⁺, and B=Fe³⁺, Al³⁺, Cr³⁺, Ti⁴⁺, V³⁺, such as cast magnetite or nonstoichiometric titanium oxides made of Magneli's phases (e.g., TiₙO₂ₙ₋₁).

In yet a further embodiment of the present disclosure, during the electrochemical reduction of the suspension, the anolyte that circulates inside the anode compartment is made of: a solution of sulfuric acid (H₂SO₄), a solution of ammonium sulfate [(NH₄)₂SO₄], a solution of cerium (III) sulfate [Ce₂(SO₄)₃], a solution of manganese (II) sulfate (MnSO₄), a solution of iron(II) sulfate (FeSO₄), or a solution of chromium (III) sulfate [Cr₂(SO₄)₃], a spent solution of vanadyle sulfate (VOSO₄), a spent vanadium electrolyte solution, or their mixtures thereof.

In yet a further embodiment of the present disclosure, the co-products obtained in the anode compartment depends on the original anolyte composition and are made of: a concentrated solution of sulfuric acid (H₂SO₄), pure oxygen gas, a solution of peroxodisulfuric acid (H₂S₂O₈), a solution of ammonium peroxodisulfate [(NH₄)₂S₂O₈], a solution of cerium(IV) sulfate [Ce(SO₄)₂], electrolytic manganese(IV) dioxide (MnO₂), a solution of iron(III) sulfate [Fe₂(SO₄)₃], a solution of chromic acid [H₂CrO₄] or a suspension of vanadium(V) oxide, or their mixtures thereof.

In yet a further embodiment of the present disclosure, the slurry electrolysis is performed at a cathode current density (CCD) from −100 A/m² to −10,000 A/m² and in a further embodiment from −1,000 A/m² to −5,000 A/m².

In yet a further embodiment of the present disclosure, the slurry electrolysis is performed at an operating temperature from 5° C. to 90° C. and in a further embodiment from 15° C. to 80° C.

In yet a further embodiment of the present disclosure, the temperature of both the catholyte and anolyte constantly rises owing to the heat generated by Joule's resistance heating and it can be controlled by installing plate and frame or tubular heat exchangers either immersed inside the storage tanks, incorporated inside the electrolyzer stack or inline within the piping circuit allowing to operate the electrolyzer at the maximum current density required to reach the highest hourly production rate.

In yet a further embodiment of the present disclosure, the catholyte circulates inside the cathode compartment with a volume flow rate from 1 US gallons per minute (3.785 L/min) to 100 US gallons per minute (378.5 L/min) and in a further embodiment from 2 US gallons per minute (7.57 L/min) to 50 US gallons per minute (189.3 L/min). In a further embodiment, from 3 US gallons per minute (11.36 L/min) to 25 US gallons per minute (94.6 L/min)

In yet a further embodiment of the present disclosure, the catholyte circulates inside the cathode compartment with a linear velocity sweeping the cathode surface from 1.0 centimeter per second to 100 centimeters per second.

In yet a further embodiment of the present disclosure, the clear pregnant solution containing the vanadium sulfates or the transition metal sulfates is further reduced electrochemically for the preparation of equilibrated vanadium electrolyte (VE) containing vanadium (IV) and vanadium (III) cations or of multiple cations of multivalent transition metals.

The foregoing and other objects, advantages and features of the present disclosure will become more apparent upon reading of the following nonrestrictive description of illustrative embodiments thereof, given by way of example only with reference to the accompanying drawings, and which should not be interpreted as limiting the scope of the present disclosure.

### BRIEF DESCRIPTION OF THE DRAWINGS/FIGURES

In the appended drawings/figures:

FIG. 1 shows a schematic illustrating specifically the major half-cell redox reactions taking place at the cathode and anode inside a divided electrolyzer when performing the preparation of an equimolar vanadium electrolyte utilizing the electrochemical reduction of a suspension of vanadium pentoxide with sulfuric acid as a carrier fluid to an embodiment of the present disclosure.

FIG. 2 shows a process and instrumentation diagram (P&ID) of an electrochemical prototype unit with related equipment illustrating an exemplary processing route performing the slurry electrolysis of a suspension of vanadium (V) oxide in sulfuric acid to prepare a vanadium sulfate electrolyte to an embodiment of the present disclosure.

FIG. 3 depicts a photograph of the electrochemical prototype unit used for the experimental testing to an embodiment of the present disclosure.

FIG. 4 shows theoretical plots of the oxidation-reduction potential (ORP) vs. the specific electric charge (Ah/kg) at various operating temperatures for obtaining an equimolar vanadium electrolyte with a total vanadium molarity of 1.6M and 1.9M respectively assuming a cathode current efficiency (CCE) of 100% respectively to an embodiment of the present disclosure.

FIG. 5 shows theoretical plots of the oxidation-reduction potential (ORP) vs. the volumetric electric charge (Ah/L) at various operating temperatures for obtaining an equimolar vanadium electrolyte with a total vanadium molarity of 1.6M and 1.9M respectively assuming a cathode current efficiency (CCE) of 100% respectively to an embodiment of the present disclosure.

FIG. 6 shows several experimental plots describing the measured oxidation reduction potential (ORP) vs. the specific electric charge (Ah/kg) during the preparation of several batches of vanadium electrolytes with various [V(IV)] and [V(III)] molar ratios to an embodiment of the present disclosure.

### DETAILED DESCRIPTION OF THE INVENTION

Glossary

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Unless otherwise indicated, the definitions and embodiments described in this and other sections are intended to be applicable to all embodiments and aspects of the application herein described for which they are suitable as would be understood by a person skilled in the art.

The word “a” or “an” when used in conjunction with the term “comprising” in the claims and/or the disclosure may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used in this disclosure and claim(s), the word “consisting” and its derivatives, are intended to be close ended terms that specify the presence of stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±1% of the modified term if this deviation would not negate the meaning of the word it modifies.

As used herein, the term “transition metal” refers according to the definition from the International Union of Pure and Applied Chemistry (IUPAC) to a chemical element whose atom has a partially filled electronic d sub-shell, or which can give rise to cations with an incomplete d sub-shell. Thus a transition metal is any element in the d-block of the periodic table, which includes groups 3 to 12 on the periodic table. On the other hand, the f-block lanthanide and actinide series are referred more specifically as inner transition metals.

As used herein, the term “transition metal oxides” refer to oxides of transition metals, oxides of rare earth, oxides of lanthanides, and oxides of actinides for instance but not limited to oxides of titanium, oxides of vanadium, oxides of chromium, oxides of manganese, oxides of iron, oxides of cobalt, oxides of nickel, oxides of cerium, oxides of praseodymium, oxides of europium, oxide of terbium, oxides of uranium, and oxides of plutonium, in various oxidation states or a mixture thereof.

The term “sulfation” is used broadly to indicate either the sulfuric acid digestion, the sulfuric acid dissolution, or the sulfuric acid leaching of transition metal oxides or a mixture thereof with sulfuric acid having a concentration in mass percentage ranging from 5 wt. % up to 100 wt. %.

The term “substantially” as used herein with reference to the process steps disclosed herein means that the process steps proceed to an extent that conversion or recovery of the material is maximized. For example, with reference to recovery of a given metallic value, recovery means that at least 90% of the value is recovered.

The present disclosure broadly relates to a process for preparing aqueous solutions of vanadium sulfates or aqueous solutions of transition metal sulfates. More specifically, but not exclusively, the present disclosure relates to a direct electrochemical process in which a suspension, obtained by slurrying transition metals oxides such as oxides of titanium, oxides of vanadium, oxides of chromium, oxides of manganese, oxides of iron, oxides of cobalt, oxides of nickel, oxides of cerium, oxides of praseodymium, oxides of europium, oxide of terbium, oxides of uranium, and oxides of plutonium, or their mixtures thereof with sulfuric acid as carrier fluid, is reduced electrochemically inside the cathode compartment of an electrolyzer to produce aqueous solutions of vanadium sulfates or aqueous solutions containing sulfates of transition metals.

In a further embodiment, the present disclosure relates to a first step consisting to perform the intimate mixing of vanadium oxides or transition metal oxides with sulfuric acid used as carrier fluid. This mixing can be made separately inside an external tank or directly by pouring the vanadium oxides or transition metal oxides solids inside the catholyte tank filled with the total required amount of sulfuric acid which is circulating with a high volume flow rate through the cathode compartment. The aim is to obtain a free-flowing and non-settling suspension of the solids or slurry inside the piping, valves and cathode compartment. Eventually, additional mixing could be provided by immersing an impeller inside the catholyte tank or installing inline mixers directly within the piping circuit.

In an embodiment, the concentration of sulfuric acid used during this step and expressed in mass percentage ranges from 5 wt. % H₂SO₄ up to 98 wt. % H₂SO₄. In a further embodiment, the concentration of sulfuric acid expressed in mass percentage ranges from 10 wt. % H₂SO₄ up to 80 wt. % H₂SO₄. In a further embodiment, the concentration of sulfuric acid expressed in mass percentage ranges from 15 wt. % H₂SO₄ up to 60 wt. % H₂SO₄. Actually, the initial concentration sulfuric acid in the carrier fluid must be equal or higher than the stoichiometric amount needed to ensure the complete dissolution of the transition metal oxides. Moreover, the suspension of the vanadium oxides or transition metal oxides with sulfuric acid as a carrier liquid yield either a non-settling or a settling slurry depending on the initial particle size distribution of the solids and the difference in mass densities between the solids and the carrier fluid.

In a further embodiment of the present disclosure, the mass percentage of suspended solids or pulp density, denoted wₛ, and equal to mₛ/(mₛ +m_{A}), with mₛ the mass of solid transition metal oxides, in kg, and m_{A} the mass of sulfuric acid, in kg, ranges from 1 wt. % solids up to 80 wt. % solids. In a further embodiment, the pulp density ranges from 5 wt. % solids up to 70 wt. % solids. In a further embodiment, the pulp density ranges from 10 wt. % solids up to 60 wt. % solids. The maximum pulp density is usually imposed by the stoichiometry of the electrochemical reduction reaction but additional factors such as the stability of the suspension, the proper wettability, the mechanical abrasion exerted on the cathode, membrane, and construction materials, and finally the rheology of the suspension can require to use a different value.

The mass density of the suspension, denoted ρ_{SUS}, and expressed in kg/m³ can be calculated from the pulp density using the equation below based and the actual mass density of the solid transition metal oxide, denoted ρ_{S}, in kg/m³ and the mass density of the aqueous solution of sulfuric acid, denoted ρ_{A}, in kg/m³ and assuming that the volume change occurring upon mixing is negligible.

ρ_{SUS}=1/[w_{S}/ρ_{S}+(1−w_{S})/ρ_{A}]

In a further embodiment of the present disclosure the vanadium oxides or the transition metal oxides exhibit a particle size below 0.500 mm, in an embodiment below 0.125 mm, in a further embodiment lower than 0.050 mm. Actually, the particle size is of paramount importance for the fluidization of the solids inside the cathode compartment, the dissolution kinetics, and also for proper hydraulic conveying inside the pumping equipment and piping.

In a further embodiment of the present disclosure, in order to maintain complete fluidization of the particles of vanadium oxides or the transition metal oxides inside the cathode compartment, the linear velocity of the fluid inside the cathode compartment must be maintained at all time equal or above the terminal settling velocity calculated for the largest solid particles. In an embodiment, the dimensionless ratio of the linear fluid velocity, u_{f}, inside the cathode compartment to the terminal settling velocity, uₜ, denoted (u_{f}/uₜ), ranges between 1 and 100. In a further embodiment, the dimensionless ratio of the linear fluid velocity to the minimum fluidization velocity ranges between 2 and 50.

In a further embodiment of the present disclosure, in order to perform the proper hydraulic conveying of the suspension of vanadium oxides or transition metal oxides inside the piping circuit, the tubes and ducts, the linear fluid velocity inside the piping and tubing must be above the terminal settling velocity calculated for the largest solid particles. In an embodiment, the dimensionless ratio of the linear fluid velocity, u_{f}, to the terminal settling velocity, u_{f}, calculated for the largest particle size, denoted (u_{f}/uₜ), ranges between 2.0 and 10,000. In a further embodiment, the dimensionless ratio of the linear fluid velocity to the terminal settling velocity ranges between 5.0 and 5,000. In yet a further embodiment, the dimensionless ratio of the linear fluid velocity to the terminal settling velocity ranges between 10 and 2,500.

Actually, it is of paramount importance for the slurry electrolysis that the suspension of the transition metal oxide in sulfuric acid can be transported by hydraulic conveying inside the piping and it remains fluidized inside the cathode compartment of the electrolyzer. The hydraulic conveying occurs when a solid particle in suspension is entrained by the moving fluid with linear velocity well above that of the terminal settling velocity of the solid particles. The drag force denoted F_{D} in newtons exerted by the moving liquid of mass density ρ_{L} in kg/m³ and linear fluid velocity, u_{f}, in m/s on a solid particle of mass density ρ_{S} in kg/m³, diameter dₚ in m, volume V_{S}, in m³, and cross sectional area Aₚ in m² is given by the following equation where C_{D} is called the empirical drag coefficient:

F_{D}=C_{D}Aₚρ_{L}u²/2=(πC_{D}/8)ρ_{L}dₚ²u²

If the fluid moves vertically upward inside a column, the solid particle is conveyed under steady condition only if buoyancy force vector F_{B}=−V_{S}ρ_{L}gₙ is greater than the sum of the drag force vector and the particle weight W=V_{S}ρ_{S}gₙ, where gₙ is the standard acceleration of gravity (9.80665 m/s²):

F_{B}=F_{D}+W

Thus the general equation for the square of terminal settling velocity is simply given by:

uₜ²=[(4gₙdₚ/3C_{D})(ρ_{S}−ρ_{L})/ρ_{L}]

Based on the above equation, it is possible to calculate the terminal settling velocity for a spherical solid particle depending on the dimensionless Reynolds number of the solid particle defined as Re=ρ_{L}udₚ/η. The various laws and equations with their selection criteria that can be used for that purpose are reported in TABLE 1.

TABLE 1
Equations for calculating the terminal settling velocity of a
spherical solid particle vs. Reynolds number (solid)

| Hydrodynamic conditions | Drag force | Terminal settling velocity |
|---|---|---|
| For laminar flows with Reₚ < 2, the drag force is | F_{D} = (6πηrₚ)μ = | Stoke’s law: |
| proportional to the linear velocity with: C_{D} = 24/Re | (3πηdₚ)μ | μₜ = [gₙdₚ²(ρ_{S} − ρ_{L})/18η] |
| For the intermediate region 2 < Reₚ < 500, the | F_{D} = (C_{D}Aₚρ_{L}μ²/2) | Intermediate law |
| terminal velocity follows the empirical equation | | μₜ = 0.152 [gₙ^{0.714} dp^{1.14}(ρ_{S} − ρ_{L})^{0.714}/η^{0.428}ρ_{L}^{0.285}] |
| with C_{D} determined graphically using Leva’s plot of | | |
| C_{D} vs. Reₚ or using: C_{D} = 18.5Re^{-0.6} | | |
| For laminar and turbulent flows with Reₚ > 500, the | F_{D} = (C_{D}Aₚρ_{L}μ²/2) | Newton’s law: |
| drag force is proportional to the linear velocity | | μₜ = [(4gₙdₚ/3C_{D})( ρ_{S} − ρ_{L})/ρ_{L}]^{0.5} |
| squared with C_{D} = 0.445 | | With C_{D} and gₙ numerical values, we obtain: |
| | | μ₁ = [29.38dₚ(ρ_{S} − ρ_{L})/ρ_{L}]^{0.5} |

Note:
spherical solid particle of outer diameter dₚ, we have: Aₚ = πdₚ² and Vₛ = πdₚ³/6

For instance, the fluidization and hydraulic conveying conditions for a FLOWPRO III electrolyzer used to perform the electrochemical reduction of a suspension of vanadium (IV) oxide with sulfuric acid is exemplified in the TABLE 2.

TABLE 2
Fluidization and hydraulic conditions inside the FLOWPRO III
electrolyzer and piping for a suspension of vanadium
pentoxide with sulfuric acid as carrier fluid.

| | Electrolyzer type FLOWPRO III | | |
|---|---|---|---|
| | | | US customary |
| | Symbol | SI units | units |
| Solid properties | | | |
| Material | | Vanadium pentoxide (V₂O₅) | |
| Mass density | ρ_{S} | 3,360 kg · m⁻³ | 209.8 lb/ft³ |
| Particle size | dp | 45 μm | 1.77 × 10⁻³ in |
| Fluid properties | | | |
| Aqueous solution | | Sulfuric acid (H₂SO₄) | |
| Mass percentage | w_{A} | 40.0 wt. % | 40.0 wt. % |
| Mass density | ρ_{A} | 1,302.8 kg · m⁻³ | 81.3 lb/ft³ |
| Dynamic viscosity | η_{A} | 4.0 mPa · s | 8.354 × 10⁻⁵ |
| | | | lb_{f}-s/ft² |
| Volume flow rate | Qᵥ | 11.36 dm³/min | 3 US gal/min |
| Piping | | NPS ½-inch Sch. 80 | |
| Inner diameter | ID | 13.87 mm | 0.546 in |
| Cross sectional area | A | 1.511 × 10⁻⁴ m² | 16.3 × 10⁻⁴ ft² |
| Hydrodynamic diameter | D_{H} | 13.87 mm | 0.546 in |
| Linear fluid velocity | u_{f} | 1.253 m · s⁻¹ | 4.111 ft/s |
| Reynolds number (fluid) | Re | 5,660 | 5,660 |
| Reynolds number | Reₚ | 18.4 | 18.4 |
| (particle) | | | |
| Settling equation type | | Intermediate law (2 < Reₚ < 500) | |
| Terminal settling velocity | uₜ | 2.58 × 10⁻⁴ m · s⁻¹ | 8.48 × 10⁻⁴ ft/s |
| Ratio linear/terminal velocity | u_{f}/uₜ | 4,848 | 4,848 |
| Cathode compartment | | | |
| Height | h | 0.3048 m | 12.0 in |
| Width | w | 0.0254 m | 1.0 in |
| Cross sectional area | A | 77.42 × 10⁻⁴ m² | 0.0833 ft² |
| Hydrodynamic diameter | D_{H} | 0.0469 m | 1.856 in |
| Linear fluid velocity | u_{f} | 0.024 m/s | 0.080 ft/s |
| Reynolds number (fluid) | Re | 373 | 373 |
| Reynolds number | Reₚ | 0.4 | 0.4 |
| (particle) | | | |
| Settling equation type | | Stoke's law (Reₚ < 2) | |
| Terminal settling velocity | uₜ | 5.67 × 10⁻⁴ m/s | 18.6 × 10⁻⁴ ft/s |
| Ratio linear/terminal velocity | u_{f}/uₜ | 43 | 43 |

In a further embodiment of the present disclosure, if the initial wettability or rheology during mixing conditions must be adjusted, chemical additives and surfactants can be eventually added to the mixture in order to improve the mixing properties or stability of the suspended solid particles.

In yet a further embodiment of the present disclosure, the suspension of vanadium oxides or of the transition metal oxides obtained after slurrying with sulfuric acid, is reduced electrochemically by performing slurry electrolysis.

In this case, it is important to identify the cathode and anode reactions to establish the overall electrochemical reaction scheme. For instance, if we consider the electrochemical reduction of a transition metal oxide with the empirical chemical formula M₂Oₓ. At the cathode, the two original transition metal cations with the higher oxidation number equal to +x yields two transition metal cations with a lower oxidation number +y, the reduction reaction (i.e., cathode reaction) taking place is:

M₂Oₓ(s)+2xH⁺+2(x−y)e⁻=2M^{y+}+xH₂O

On the other hand, if the anolyte is made of sulfuric acid, the oxidation reaction (i.e., anode reaction) occurring at the anode is:

H₂O=0.5O₂(g)↑+2H⁺+2e⁻

Balancing the two half reactions above, we obtain the overall electrochemical reaction:

M₂Oₓ(s)+2yH⁺=2M^{y+}[(x−y)/2]O₂(g)↑+yH₂O

If we introduce sulfate anions for balancing the electric charge, the above electrochemical equation becomes:

M₂Oₓ(s)+yH₂SO₄=M₂(SO₄)_{y}+[(x−y)/2]O₂(g)↑+yH₂O

Similarly, a more general chemical equation scheme can be devised when the electrochemical reduction is carried-on until the two initial transition metal cations of higher oxidation number +x yields two cations, the first with a stoichiometric coefficient v and lower oxidation number +y, and the second with a stoichiometric coefficient (2−v) and lower oxidation number +z, with their molar ratio denoted: R_{yz}=[v/(2−v)], the reduction (i.e., cathode reaction) is then:

M₂Oₓ(s)+2xH⁺+[2x−vy−(2−v)z]e⁻=vM^{y+}+(2−v)M^{z+}+xH₂O

Therefore, overall electrochemical reaction must be rewritten as follows:

2M₂Oₓ(s)+[vy+(2−v)z]H₂SO₄=vM₂(SO₄)_{y}+(2−v)M₂(SO₄)_{z}+[2x−vy−(2−v)z]/2O₂(g)↑+[vy+(2−v)z]H₂O

In order to calculate the electric charge and then the current required to achieve the electrochemical reduction, it is necessary to know the specific electrochemical equivalent, that is, the charge per unit mass of the transition metal oxide of chemical formula M₂Oₓ, denoted E_{q}, and expressed in Ah/kg. The electrochemical equivalent is calculated, based on the previous cathode reaction scheme, from the molar mass of the transition metal oxide, M_{M2Ox}, in kg/mol, the Faraday's constant of 26.801 Ah/mol, and the number of electrons exchanged during reduction as follows:

E_{q}(Ah/kg)=[2x−vy−(2−v)z]F/M_{M2Ox}

Introducing the molar ratio R_{yz}, defined previously, the above equation becomes:

E_{q}(Ah/kg)=[2x−vy−(v/R_{yz})z]F/M_{M2Ox}

Then, we can calculate the theoretical specific and volumetric electric charge, denoted qₘ and qᵥ, and expressed in Ah/kg and Ah/dm³ (i.e., Ah/L) of catholyte respectively knowing the total mass percentage w_{M2Ox}, mass concentration of the transition metal oxide, C_{M2Ox}, in g/L, and the total mass concentration of the transition metal, C_{M}, in g/L:

qₘ(Ah/kg)=w_{M2Ox}E_{q}(Ah/kg)

qᵥ(Ah/dm³)=(C_{M2Ox}/1000)E_{q}(Ah/kg)=2(C_{M}/1000)E_{q}(Ah/kg)

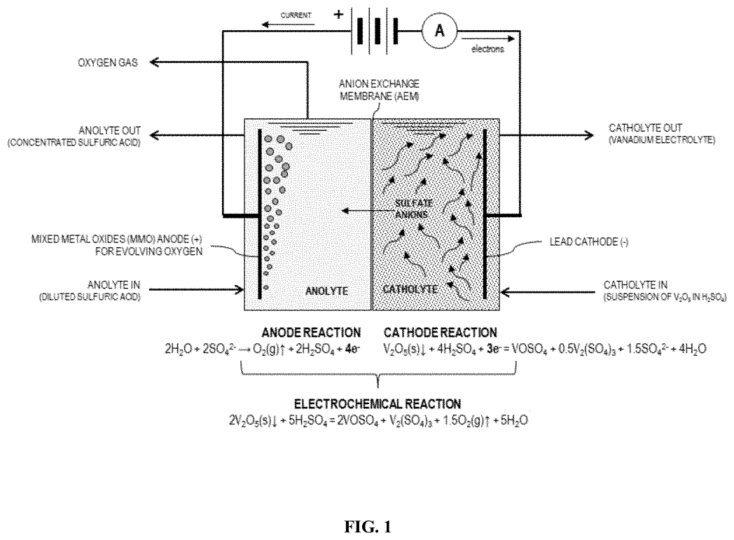

To illustrate the above electrochemical reactions and the calculations of the physical quantities, we have summarized them in the particular case of the electrochemical reduction of vanadium (V) oxide and iron (III) oxide that are reported respectively in TABLE 3 and TABLE 4 respectively and the mechanism illustrated in FIG. 1.

TABLE 3
Major half-cell redox reactions and the overall reaction for the
electrochemical reduction of vanadium (V) oxide in sulfuric
acid to prepare an equimolar vanadium electrolyte.

| | |
|---|---|
| Cathode reaction (−) | V₂O₅(s)↓ + 4H₂SO₄ + 3e⁻ = VOSO₄ + 0.5V₂(SO₄)₃ + 1.5SO₄²⁻ + 4H₂O |
| Anode reaction (+) | H₂O + SO₄²⁻ → 0.5O₂(g)↑ + H₂SO₄ + 2e⁻ |
| Overall reaction | 2V₂O₅(s)↓ + 5H₂SO₄ = 2VOSO₄ + V₂(SO₄)₃ + 1.5O₂(g)↑ + 5H₂O |
| Specific electric charge | qᵥ(Ah/dm³) = {[V(IV)] + 2[V(III)]}F(Ah/mol) |
| Volumetric electric | qₘ(Ah/kg) = {[V(IV)] + 2[V(III)]}F(Ah/mol)}/ρ_{SOLN} |
| charge | |

TABLE 4
Major half-cell redox reactions and the overall electrochemical reaction
for the reduction of iron (III) oxide (hematite) in sulfuric
acid to prepare a solution of iron (II) sulfate.

| | |
|---|---|
| Cathode reaction (−) | Fe₂O₃(s)↓ + 3H₂SO₄ + 2e⁻ = 2FeSO₄ + SO₄²⁻ + 3H₂O |
| Anode reaction (+) | H₂O + SO₄²⁻ → 0.5O₂(g)↑ + H₂SO₄ + 2e⁻ |
| Overall reaction | Fe₂O₃(s)↓ + 2H₂SO₄ = 2FeSO₄ + 0.5O₂(g)↑ + 2H₂O |
| Specific electric | qᵥ(Ah/dm³) = [Fe(II)]F(Ah/mol) |
| charge | |
| Volumetric electric | qₘ(Ah/kg) = [Fe(II)]F(Ah/mol)/ρ_{SOLN} |
| charge | |

Once the overall electrochemical reaction is established, it is then possible to calculate the theoretical masses of concentrated sulfuric acid, of pure water, and of the transition metal oxide to be mixed and electro-reduced to prepare a given aqueous solution.

In the particular case, where the transition metal oxide is pure vanadium (V) oxide that is used for preparing of volume of solution V_{SOLN}=1,000 dm³ (liters) of equimolar vanadium electrolyte with the following formulation, that is, [V(total)]=1.6 M and [H₂SO₄(free)]=2 M the exact masses of chemical reagents can be obtained using a step by step calculation as follows based on the cathode reaction previously reported in TABLE 3.

Step 1: Based on a targeted molarity for the total vanadium [V(total)] of 1.6 M, and a molar ratio [V(IV)]/[V(III)] of 1.0, the molarities of the two vanadium species are: [V(IV)]=0.8 M and [V(III)]=0.8 M respectively. The targeted molarity of the free-sulfuric acid remaining in the final electrolyte solution is: [H₂SO₄(free)]=2 M.

Step 2: The mass of total vanadium, mᵥ, in kg, and that of vanadium (V) oxide, m_{V2O5}, in kg, are calculated using the two equations:

mᵥ=[V(total)]V_{SOLN}M_{V}=81.51 kg of vanadium

m_{V2O5}=0.5[V(total)]V_{SOLN}M_{V2O5}=145.50 kg of V₂O₅

Where M_{V} and M_{V2O5} are the molar masses for vanadium (50.94×10⁻³ kg/mol) and vanadium (V) oxide (181.88×10⁻³ kg/mol) respectively.

Step 3: The mass of sulfuric acid consumed during the electrochemical reaction, m_{A}(reaction), in kg, for producing vanadium (IV) and (III) sulfates, and the mass of free sulfuric acid, m_{A}(free), in kg, remaining in the vanadium electrolyte are calculated using the two equations, where M_{H2SO4} is the molar mass for sulfuric acid (98.08×10⁻³ kg/mol):

m_{A}(reaction)=2[V(total)]V_{SOLN}M_{H2SO4}=313.86 kg of sulfuric acid

m_{A}(free)=[H₂SO₄(free)]V_{SOLN}M_{H2SO4}=196.16 kg of sulfuric acid

The total mass of sulfuric acid, m_{A}(total) , in kg, required to perform the preparation is:

m_{A}(total)=m_{A}(reaction)+m_{A}(free)=510.02 kg of sulfuric acid

On the other hand, the mass loss, m_{SO4}(loss), in kg, due to the migration towards the anode of sulfate anions (SO₄²⁻) across the anion exchange membrane (AEM) is, where M_{SO4} is the molar mass for sulfate anions (96.06×10⁻³ kg/mol):

m_{SO4}(loss)=0.75[V(total)]V_{SOLN}M_{SO4}=115.27 kg of sulfate anions

Therefore, the total mass of chemical reagents less the mass of sulfate anions lost by migration, m_{TR}, in kg, is given by the sum:

m_{TR}=m_{V205}m_{A}(reaction)+m_{A}(free)−m_{SO4}(loss)=540.25 kg

Finally, the total mass of water, m_{water}(total), in kg, to be added is given

m_{water}(total)=(ρ_{SOLN}V_{SOLN}−m_{TR})

At this point, it will be mandatory to calculate the mass density of the final vanadium electrolyte solution, ρ_{SOLN}, in kg/m³, to be able to calculate the exact mass of water.

Step 4: For calculating the theoretical mass density of the vanadium electrolyte solution, we need to calculate the mass and then the volume occupied of the free sulfuric acid, the anhydrous vanadium (III) sulfate [V₂(SO₄)₃] denoted V3 S, and the vanadium (IV) sulfate 5-hydrated (VOSO₄.5H₂O), denoted V4SH, that will be produced using the following equation where M_{V4SH} and M_{V3S} are the molar masses for VOSO₄.5H₂O (253.08×10⁻³ kg/mol) and V₂(SO₄)₃ (390.07×10⁻³ kg/mol) respectively:

m_{V4SH}=[V(IV)]V_{SOLN}M_{V4SH}=202.46 kg of VOSO₄.5H₂O

m_{V3S}=0.5[V(III)]V_{SOLN}M_{V3S}=156.03 kg of V₂(SO₄)₃

m_{A}(free)=[H₂SO₄(free)]V_{SOLN}M_{H2SO4}=196.16 kg of sulfuric acid

The volume occupied by each sulfate in the aqueous solution is simply obtained by dividing the above masses by their respective mass densities as follows:

V_{V4SH}=m_{V4SH}/ρ_{V4SH}=100.18 dm³

V_{V3S}=m_{V3S}/ρ_{V3S}=49.69 dm³

V_{A}(free)=m_{A}(free)/ρ_{A}=106.90 dm³

Where, ρ_{A}, is the mass density of pure sulfuric acid (1,835 kg/m³), ρ_{V4SH}, is the mass density of VOSO₄.5H₂O (2,021 kg/m³), and, ρ_{V3S}, is the mass density of V₂(SO₄)₃ (3,140 kg/m3).

Then subtracting the above partial volumes to the total volume of solution, and multiplying with the density of water measured at 20° C. (=998.204 kg/m³) we obtain the volume of uncombined water:

m_{water}(free)={V_{SOLN}−[V_{V4SH}+V_{V3S}+V_{A}(free)]}=743.23 kg of uncombined water

Now if we had the mass of water immobilized in the sulfate hydrate VOSO₄.5H₂O, we obtain the total mass of water where, M_{H2O}, is the molar mass of pure water (18.01×10⁻³ kg/mol):

m_{water}(total)=m_{water}(free)+m_{V4SH}(5M_{H2O}/M_{V4SH})=815.27 kg of total water

It is important to mention that the above mass of water is the water added initially to the other reagents and it does not comprise the water produced by the electrochemical sulfation reaction, that is:

m_{water}(reaction)=2[V(total)]V_{SOLN}M_{H2O}=57.63 kg of water produced

Therefore, we can now calculate the theoretical mass density of the vanadium electrolyte solution as follows:

ρ_{SOLN}=[m_{V2O5}+m_{A}(reaction)+m_{A}(free)−m_{SO4}(loss)+m_{water}(total)]/V_{SOLN}=1,356 kg/m³

The summary of the results from the above calculations are reported in TABLE 5 showing also for the sake of clarity the breakdown between the chemical elements, the anhydrous metal sulfates and the hydrated metal sulfates.

TABLE 5
Chemical reagents required for preparing 1.0 m³ of equimolar vanadium electrolyte with [V(total)] = 1.6M and [H₂SO₄] = 2M

| | | | | | | | | |
|---|---|---|---|---|---|---|---|---|
| V₂O₅ | 145.50 kg | VOSO_{4.}5H₂O | 202.46 g/L | VOSO₄ | 130.40 g/L | Vanadium | 81.51 g/L | 1.6 mol/L |
| | | V₂(SO₄)₃ | 156.03 g/L | V₂(SO₄)₃ | 156.03 g/L | (total) | | |
| H₂O | 815.27 kg | H₂O | 800.86 g/L | H₂O | 872.90 g/L | Total water | 872.90 g/L | 48.5 mol/L |
| H₂SO₄ | 510.02 kg | H₂SO₄ | 196.16 g/L | H₂SO₄ | 196.16 g/L | Free H₂SO₄ | 196.16 g/L | 2.0 mol/L |
| Total = | 1,470.79 kg | Total = | 1,355.51 g/L | Total = | 1,355.13 g/L | Total SO₄² | 384.25 g/L | 4.0 mol/L |
| Less | 1,355.52 kg | V_{SOLN} | 1.000 m³ | Mass | 1355 kg/m3 | Migration | 115.27 g/L | |
| SO₄²⁻ | migrating | | | density | | SO₄² | | |

In yet a further embodiment of the present disclosure, the electrochemical reduction is performed using a divided electrolyzer. The suspension of vanadium oxides or transition metal oxides in sulfuric acid is the catholyte and it circulates inside the cathode compartment. The separator is either a diaphragm or an ion exchange membrane. Actually, according to the reduction reactions at the cathode exemplified in the TABLE 3 and TABLE 4, sulfate anions are produced inside the cathode compartment and they must be able to migrate across the separator in order to combine with the protons produced at the anode for yielding sulfuric acid. Thus, the utilization of an anion exchange membrane (AEM) allows to increase the selectivity towards sulfate anion and to block the protons to enter the cathode compartment (i.e., proton rejection).

The electrolyzer comprises a cathode made of: lead or its alloys, aluminum and its alloys, iron and its alloys, nickel and its alloys, copper and its alloys, cadmium and its alloys, zinc and its alloys, titanium and its alloys, zirconium and its alloys, hafnium and its alloys, niobium and its alloys, tantalum and its alloys, mercury and mercury amalgams, graphite or electrically conductive ceramics with the spinel structure with chemical formula A^{II}B^{III}₂O₄ where A=Fe²⁺, Co²⁺, Ni²⁺, Mg²⁺, Cu²⁺, and B=Fe³⁺, Al³⁺, Cr³⁺, Ti⁴⁺, V³⁺, such as cast magnetite or nonstoichiometric titanium oxides made of Magneli's phases (e.g., TiₙO₂ₙ₋₁). The selection of the suitable cathode materials is of paramount importance, as it must impedes the occurrence of parasitic hydrogen gas evolution reaction (HER) and hence to promote the reduction of the transition metal cations.

The major property of the cathode material which is relevant to minimize the HER is the cathode overvoltage or overpotential. The cathode overvoltage, denoted η_{c} in volts, is simply defined as the difference between the cathode potential measured a given cathode current density j_{c} in A/m² vs. a reference electrode (RE), denoted Eⱼ, in V/RE and the standard electrode potential for the reduction of the proton, when no current is circulating (j_{c}=0) , E_{H2} calculated from the Nernst equation using the actual temperature et protons activity, a_{H+}.

η_{c}=Eⱼ−E_{H2}

The practical measurement of the hydrogen overvoltage at a given current density, is performed by recording the polarization curve, that is, the cathode potential vs. the cathode current density (E_{c}, j_{c}) for a given mass percentage of sulfuric acid, and operating temperature. Afterwards, the curve is linearized by plotting the cathode overpotential vs. the decimal logarithm of the cathode current density (η_{c}, log₁₀j_{c}). The semi-log plot obtained exhibits two distinct linear regions depending on the current regime. One linear section is valid for low cathode current densities ranging from −100 A/m² to −2,000 A/m² while the second portion for a high current densities ranging from −2,000 A/m² to −10,000 A/m². In both cases, the two straight lines satisfy to the Tafel's equation as follows :

ηᵢC=a+b log₁₀j_{c}

Where the two Tafel's coefficients, a, and b, are the ordinate in V and the slope in V/decade respectively.

On the other hand, it is important to know the cathode potential for performing the electrochemical reduction. This requires to calculate the Nernst standard electrode potential E⁰ (T) for the redox couple (M^{x+}/M^{y+}) at the operating temperature. The empirical equations of the Nernst standard electrode potential E⁰(T) as a function of the absolute thermodynamic temperature T in K are derived from thermochemical calculations aiming first to establish the temperature variations of the molar Gibbs enthalpy [ΔG=f(T)] that exhibits the general form:

ΔG(T)=ΔH(T)−TΔS(T)=[ΔH(T₀)−ΔaT₀−0.5ΔbT₀²+Δc/T₀+ΔHₜᵣ]+[Δa(1+lnT₀)−ΔS(T₀)+ΔbT₀−0.5Δc/T₀²−ΔSₜᵣ]T−0.5ΔbT²−(Δc/2)/T−ΔaTlnT

Where ΔG, ΔH, and ΔS are the variations of molar Gibbs energy, of molar enthalpy, both in J/mol and of molar entropy, in J/(mol.K), for the electrochemical reaction. The coefficients Δa, Δb, and Δc are the variations of the coefficients for the molar specific heat (Cₚ=a+bT+cT²) between the products and reactants, and ΔHₜᵣ, and ΔₜᵣS are the latent molar enthalpy and molar entropy in case a phase change occurs within the temperature range considered.

Then the Nernst standard electrode potential difference is obtained based on the equation: ΔE(T)=ΔG(T)/nF where n is the number of electrons exchanged and F the Faraday constant (i.e., 96,485.309 C/mol). Some examples of temperature dependence for the Nernst standard electrode potentials for selected redox couples of transition metal cations are reported in TABLE 6.

TABLE 6
Nernst standard electrode potentials (V/SHE) vs. absolute
thermodynamic temperature (K) for redox couples of selected transition metals.

| | E°₂₉₈ | |
|---|---|---|
| Redox couple | (V/SHE) | Nernst standard electrode potential as a function of the absolute temperature in kelvins (*) |
| V(V)/V(IV) | +1.000 | E°_{T}(V/SHE) = +0.93884 − 2.51276 × 10⁻³ T − 5.24274 × 10⁻⁷T² − 2.38503/T + 5.09689 × 10⁻⁴ TlnT |
| V(IV)/V(III) | +0.337 | E°_{T}(V/SHE) = +1.09045 − 3.32643 × 10⁻³ T − 4.96521 × 10⁻⁷T² − 0.21682/T + 1.66708 × 10⁻⁴ TlnT |
| V(III)/V(II) | −0.255 | E°_{T}(V/SHE) = −0.26760 − 1.00198 × 10⁻³ T + 4.93486 × 10⁻⁷T² − 1.30092/T + 1.60026 × 10⁻⁴ TlnT |
| Fe(III)/Fe(II) | +0.771 | E°_{T}(V/SHE) = −0.33270 + 4.06057 × 10⁻³ T + 4.00337 × 10⁻⁷T² + 0.16044/T − 1.79922 × 10⁻⁴ TlnT |
| Cr(VI)/Cr(III) | +1.360 | E°_{T}(V/SHE) = +1.57572 − 5.59780 × 10⁻³ T − 4.41734 × 10⁻⁷T² − 1.30092/T + 8.81771 × 10⁻⁴ TlnT |
| Ti(IV)/Ti(III) | +0.100 | E°_{T}(V/SHE) = +0.51171 − 5.34308 × 10⁻³ T − 5.24274 × 10⁻⁷T² − 2.38503/T + 7.54804 × 10⁻⁴ TlnT |

Notes:
(*) by definition, the Nernst standard electrode potential E°₂₉₈ (2H⁺/H₂) = 0.000 V/SHE at all temperatures

In yet a further embodiment of the present disclosure, during the electrolysis, the anolyte that circulates inside the anode compartment is made of: a solution of sulfuric acid (H₂SO₄), a solution of ammonium sulfate [(NH₄)₂SO₄], a solution of cerium (III) sulfate [Ce₂(SO₄)₃], a solution of manganese (II) sulfate (MnSO₄), a solution of iron(II) sulfate (FeSO₄), or a solution of chromium (III) sulfate [Cr₂(SO₄)₃], a solution of vanadyle sulfate (VOSO₄), a spent vanadium electrolyte solution, or their mixtures thereof.

The electrolyzer comprises an anode made of: titanium or titanium alloy coated with mixed metal oxides (MMO), niobium or niobium alloys coated with mixed metal oxides (MMO), tantalum and tantalum alloys coated with mixed metal oxides (MMO), lead and its alloys, lead dioxide, or electrically conductive ceramics with the spinel structure with chemical formula A^{II}B^{III}₂O₄ where A=Fe²⁺, Co²⁺, Ni²⁺, Mg²⁺, Cu²⁺, and B=Fe³⁺, Al³⁺, Cr³⁺, Ti⁴⁺, V³⁺, such as cast magnetite or nonstoichiometric titanium oxides made of Magneli's phases (e.g., TiₙO₂ₙ₋₁)

In yet a further embodiment of the present disclosure, during the electrolysis, a co-product is obtained in the anode compartment. The co-product depends on the anolyte composition, the type of anode material, and the operating conditions (e.g., temperature, current density).

In yet a further embodiment of the present disclosure, co-products are: a concentrated solution of sulfuric acid (H₂SO₄), pure oxygen gas, a solution of peroxodisulfuric acid (H₂S₂O₈), a solution of ammonium peroxodisulfate [(NH₄)₂S₂ₗO₈], a solution of cerium (IV) sulfate [Ce(SO₄)₂], electrolytic manganese (IV) dioxide (MnO₂), a solution of iron (III) sulfate [Fe₂(SO₄)₃], a solution of chromic acid [H₂CrO₄] or a suspension of vanadium (V) oxide, or their mixtures thereof.

In yet a further embodiment of the present disclosure, the slurry electrolysis is performed at a cathode current density (CCD) from −100 A/m² to −10,000 A/m² and in a further embodiment from −1,000 A/m² to −5,000 A/m².

In yet a further embodiment of the present disclosure, the slurry electrolysis is performed at an operating temperature from 5° C. to 90° C. and in a further embodiment from 15° C. to 80° C.

In yet a further embodiment of the present disclosure, the temperature of both the catholyte and anolyte constantly rises owing to the heat generated by Joule's resistance heating and it can be controlled by installing plate and frame or tubular heat exchangers either immersed inside the storage tanks, incorporated inside the electrolyzer stack or inline within the piping circuit allowing to operate the electrolyzer at the maximum current density required to reach the highest hourly production rate.

In yet a further embodiment of the present disclosure, the catholyte circulates inside the cathode compartment with a volume flow rate from 1 US gallons per minute (3.785 L/min) to 100 US gallons per minute (378.5 L/min) and in a further embodiment from 2 US gallons per minute (7.57 L/min) to 50 US gallons per minute (189.3 L/min). In a further embodiment, from 3 US gallons per minute (11.36 L/min) to 25 US gallons per minute (94.6 L/min)

In yet a further embodiment of the present disclosure, the catholyte circulates inside the cathode compartment with a linear velocity sweeping the cathode surface from 1.0 centimeter per second to 100 centimeters per second.

In a further embodiment, the slurry electrolysis is performed for a daily period duration ranging from thirty (30) minutes up to twenty four (24) hours, in a further embodiment from one (1) hour up to twelve (12) hours and in a further embodiment from four (4) hours up to eight (8) hours.

In yet a further embodiment of the present disclosure, the electrolysis is carried-on for the preparation of equilibrated vanadium electrolyte (VE) containing vanadium (IV) and vanadium (III) cations or of multiple cations of multivalent transition metals.

In order to assess the performances and figures of merit of the electrochemical reduction of the transition metal oxides, it is important to introduce hereafter five physical quantities: (1) the cathode current efficiency (CCE), (2) the electrochemical conversion yield (ECY), (3) the specific and volumetric energy consumptions (SEC, VEC), and (4) the space time yield (STY).

The cathode current efficiency (CCE) is the dimensionless ratio of the theoretical electric charge required to perform the stoichiometric reduction to the actual charge circulated to complete the electrochemical reduction. It is calculated from the ratio of the electrochemical equivalent per unit mass of oxide to be reduced, E_{q}(Ah/kg), times the mass of transition metal oxide, m_{M2Ox}, in kg, divided by the product of the total current I in A, times the electrolysis duration, Δt, in hours.

CCE (%)=100m_{M2Ox}E_{q}/(I·Δt)

It can be also calculated using the specific and volumetric electric charges described previously in this section, knowing the volume of the catholyte produced, V_{SOLN}, in m³, and the mass density of the final solution, ρ_{SOLN} in kg/m³:

CCE (%)=100·[qₘρ_{SOLN}V_{SOLN}/(IΔt)]=100·[qᵥV_{SOLN}/(IΔt)]

The electrochemical conversion yield (ECY) is the dimensionless ratio of the total mass of transition metal brought into solution divided by the actual mass of transition metal cations produced.

ECY (%)=100 (M_{M2Ox})·[M(total)]V_{SOLN}/(w_{M2Ox}m_{M2Ox})

In addition to the physical quantities already described above, [M(total)]·is the actual molarity of total transition metal cations in mol/m³, w_{M2Ox} is the purity of the transition metal oxide, M_{M2Ox}, is the molar masse of the transition metal oxide in kg/mol.

The specific energy consumption (SEC) in Wh/kg is the ratio of the averaged overall cell voltage, <U_{cell}>, in V, times the integrated charge, (∫Idt), in Ah circulated per unit mass of transition metal oxide reduced, in kg. It can be also calculated directly from the electrochemical equivalent, the averaged overall cell voltage, and the cathode current efficiency, as follows:

SEC (Wh/kg)=<U_{cell}>(∫Idt)/m_{M2Ox}=<U_{cell}>E_{q}/CCE

It is also possible to define the specific energy consumption (SEC_{SOLN}), in Wh/kg, which is the energy consumed per unit mass of catholyte solution, as follows:

SEC_{SOLN}(Wh/kg)=<U_{cell}>(∫Idt)]/m_{SOLN}

Similarly, the volumetric energy consumption (VEC_{SOLN}), in Wh/m³, is the energy consumed per unit volume of catholyte solution:

VEC (Wh/m³)=<U_{cell}>(∫Idt)]/V_{SOLN}

The space time yield (STY) in kg.m⁻².h⁻¹ is the mass of transition metal oxide reduced per unit time and per unit cathode surface area. It corresponds to the cathode current density times the cathode current efficiency divided by the electrochemical equivalent as follows:

STY(kg.m⁻²h⁻¹)=CCE×(j_{c}/E_{q})

Similarly, it is also possible to calculate a space time yield (STY_{SOLN}) as the volume of electrolyte solution produced per unit time, and cathode surface area, as follows:

STY(L.m⁻²h⁻¹)=CCE×(j_{c}/qᵥ)

The utilization of the above performances and figures of merit will be exemplified in the experimental section.

The foregoing and other objects, advantages and features of the present disclosure will become more apparent upon reading of the following nonrestrictive description of illustrative embodiments thereof, given by way of example only with reference to the accompanying drawings, and which should not be interpreted as limiting the scope of the present disclosure.

### Experimental

A number of examples are provided herein below, illustrating the efficiency of the process of the present disclosure in the preparation of aqueous solutions of vanadium sulfates or transition metal sulfates by the electrochemical reduction of suspensions of vanadium oxides or transition metal oxides in sulfuric acid as carrier fluid.

### EXAMPLE 1

Plate and frame divided electrolyzer for performing the electrochemical reduction of slurries: The electrochemical reduction of a suspension of vanadium pentoxide and sulfuric acid was performed inside the cathode compartment of a commercial FLOWPRO III or FLOWPRO IV divided electrolyzer of the plate and frame type with two compartments manufactured by Electrochem Technologies & Materials Inc. (Montreal, QC, Canada). The two compartments were separated by a sheet of an anion exchange membrane AEM-MIM-UL-2019. The cathode compartment was equipped with a square cathode made of ¼-inch (6.35 mm) thick pure chemical lead (“corroding lead”) plate. The anode compartment was equipped with an anode plate made of titanium coated with mixed metal oxides (MMO) of the type MMO-IRO-TI2-HD manufactured by Electrochem Technologies & Materials Inc. (Montreal, QC, Canada) with a customized formulation for the electro catalyst coating capable to withstand high anode current densities and extended service life in concentrated aqueous solutions of sulfuric acid. Moreover, a flexible PP plastic mesh was wrapped and installed inside both the cathode and anode compartments in order to promote the mass transfer, and also to reinforce the mechanical stiffness of the membrane. The technical specifications for each electrolyzer model including the dimensions and configuration of the electrodes and membrane are reported in TABLE 7.

TABLE 7
Technical specifications of the FLOWPRO III and FLOWPRO IV plate
and frame electrolyzer used to perform slurry electrolysis.

| ELECTROLYZER | FLOWPRO III | FLOWPRO IV |
|---|---|---|
| Cathode shape | Square plate | Rectangular plate |
| Cathode dimensions and geometric | 12-in tall × 12-in width | 16-in tall × 12-in width |
| surface area (maximum) | 144 in² (0.093 m²) | 192 in² (0.124 m²) |
| Volume of cathode compartment | 250 in³ (4,097 dm³) | 324 in³ (5,309 dm³) |
| | 1.082 gallons (US) | 1.403 gallons (US) |
| Electrodes-membrane gap (minimum) | 1 in (2.54 cm) | 1 in (2.54 cm) |
| Inter-electrodes gap (minimum) | 2 in (5.08 cm) | 2 in (5.08 cm) |
| Membrane shape | Square sheet | Rectangular sheet |
| Membrane dimensions and geometric | 12-in tall × 12-in width | 16-in tall × 12-in width |
| surface area (maximum) | 144 in² (0.093 m²) | 192 in² (0.124 m²) |
| Anode shape | Square plate | Rectangular plate |
| Anode dimensions and geometric surface | 12-in tall × 12-in width | 16-in tall × 12-in width |
| area (maximum) | 144 in² (0.093 m²) | 192 in² (0.124 m²) |
| Maximum allowable current per unit cell | 380 A | 500 A |
| (with external cooling) | | |

### EXAMPLE 2

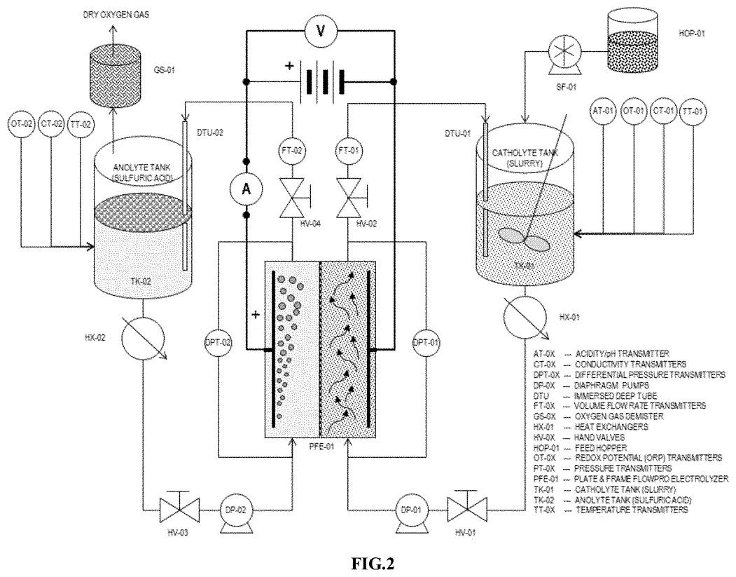

Prototype installation setup for performing the electrochemical reduction of slurries: A schematic process and instrumentation diagram (P&ID) illustrating the electrochemical prototype setup for electrolyzing a slurry of vanadium pentoxide with sulfuric acid inside the cathode compartment of the FLOWPRO III and FLOWPRO IV electrolyzer described in the previous example in accordance with an embodiment of the present disclosure, is shown in FIG. 2. Each compartment is connected to the related catholyte (resp. anolyte) storage tank with a capacity of 5 gallons (18.9 L) for FLOWPRO III and 15 gallons (56.8 L) for FLOWPRO IV, through NPS ½-inch Schedule 80 piping made of PVC type II.

The circulation of the catholyte (resp. anolyte) is ensured by two diaphragm pumps with a volume flow rate up to 3 gal/min (11.4 L/min) that correspond to a linear velocity of 4 ft/s (1.21 m/s) inside the piping below the limit of 7 ft/s (2.13 m/s) imposed by the piping manufacturer but enough to ensure the proper hydraulic conveying of the suspended solids. Several ball valves were installed at several key locations for controlling the volume flow rate and/or isolate certain sections of the prototype setup during shutdown and maintenance. The volume flow rates were measured using two rotameters and the fluid pressures using corrosion resistant pressure gauges. Finally a strainer with a removable basket was also installed in order to filter particulates eventually present in the catholyte after the completion of the electrolysis.

The headspace of the catholyte tank included a Teflon®-PFA tubing with an outer diameter of ¼-inch (6.35 mm) connected to an argon gas cylinder of 2,900 psig (200 bar), through a two-stage gas regulator and gas flowmeter capable to maintain a blanket of inert gas above the catholyte surface for preventing air-oxidation of the V(III) species once produced at the end of the slurry electrolysis. The choice of argon over other inert gases such as nitrogen was based: (1) on density considerations, that allow the denser argon gas to remain trapped inside the tank's head space by contrast with lighter nitrogen gas that continuously escapes, and (2) on electrochemical considerations as the possible dissolution of some nitrogen gas into the catholyte and its conversion to ammonium cations and hydrazine (N₂H₄) inside the cathode compartment that could lead to current inefficiencies, and contamination by unwanted species.

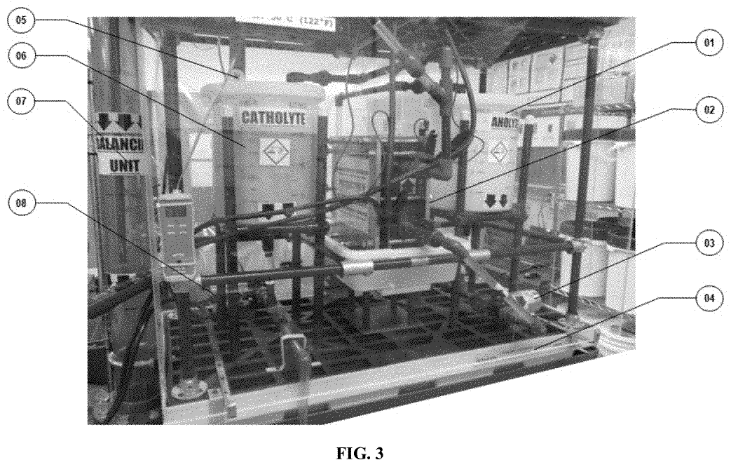

The anolyte consisted of an aqueous solution of sulfuric acid. Because of the important oxygen gas evolution occurring inside the anode compartment, the anolyte storage tank was filled by polypropylene (PP) balls with ½-inch (12.7 mm) outer diameter floating at the surface for preventing the entrainment of droplets of acid, while the pure oxygen gas was released to the atmosphere after passing through a tall disengagement vessel acting as a demister in order to perform efficiently liquid/gas separation. A perforated disk made of PVC with ⅜-inch (9.525 mm) openings was installed at the bottom of the anolyte tank to prevent obstruction of the piping outlet by the PP balls when emptying the tank. In addition, a balancing unit consisting of a 5-foot tall flanged NPS 6-in nominal pipe Schedule 40 made of clear PVC was installed on the left-hand side and connected to the catholyte compartment in order to perform the balancing and equilibration of the vanadium electrolyte outside the catholyte tank if required. This unit is depicted in the photograph of FIG. 3 and identified by the item number 7.

The slurry electrolysis was performed under a batch mode with recirculation until completion of the electrochemical reduction. An industrial DC power supply Model EMI SCR20-500 (TDK-Lambda, USA) with maximum rating at 500A DC and 20V (10 kW) was used to perform the electrolysis under a constant current operation. Thick copper plates acting as busbars for each electrode were connected to the power supply with 25-ft long flexible cables made of sheathed stranded copper wire with PVC as outer insulation. The gauge for each cable was 350 MCM (thousand circular mils) [i.e., OD 1.05 inch (26.67 mm)] with a DC current rating of 310 A at 86° C. from McMaster-Carr (Aurora, Ohio, USA). The overall cell voltage (U_{cell}) was measured with a high impedance voltmeter, the instantaneous total current (I) was measured with a battery shunt and also checked regularly with a clamp ammeter directly on the cables.

When performing the electrolysis at high current intensity, the increasing temperature of the electrolytes by Joule's heating needed to be controlled by using two heat exchangers in order to maintain the operating temperature below 50° C. to keep the mechanical integrity of the PVC pipes and frames. The temperatures of the catholyte and anolyte were measured using two type-K thermocouples (OMEGA Engineering, USA) directly immersed at the bottom of each tanks and protected against corrosion by a ¼-inch OD Teflon®-PFA sheath.

The oxidation redox potential (ORP) of the catholyte was measured continuously with a custom build ORP probe constructed with a platinum-rhodium (Pt-Rh) inert electrode vs. a mercury-mercury sulfate-sulfuric acid (MSSA) reference electrode [i.e., Hg/Hg₂SO₄//H₂SO₄(30 wt. %)] the latter supplied from Koslow Scientific Company (Englewood, N.J., USA) and immersed deep inside the catholyte tank. The ORP is of paramount importance to the electrolytic process as it is indicative of the progression of the electrochemical reduction reaction. For verification, small samples are also checked from time to time with a commercial ORP probe with platinum vs. a silver-silver chloride—potassium chloride [i.e. Ag/AgCl//KCl(3.5M)] as reference electrode supplied by Cole Parmer Canada (Montreal, QC, Canada). The latter method was used in order to avoid contaminating the final vanadium electrolyte with extraneous potassium cations and chloride anions. The electrical conductivity (κ) was measured using a toroidal probe from GLI-ThermoFisher. All the operating parameters were recorded using data loggers.

The photograph of the pilot setup using a FLOWPRO III electrolyzer is depicted in FIG. 3 where (1) denotes the 5-gallon anolyte tank, (2) the FLOWPRO III plate and frame electrolyzer, (3) the anolyte diaphragm pump, (4) the rectangular spill container, (5) the ORP probe, (6) the 5-gallon catholyte tank, (7) the balancing unit, and finally (8) the catholyte diaphragm pump.

### Example 3

Measurement of the cathode overvoltage for the hydrogen gas evolution reaction, and calculations of the Tafel's coefficients for selected industrial cathode materials: The measurements of the cathode overvoltage for the hydrogen gas evolution reaction, and for the determination of the Tafel's coefficients was performed using a RECTALB V laboratory cell manufactured by Electrochem Technologies & Materials Inc. (Montreal, Qc, Canada) that consisted to a divided plate and frame electrolyzer made of polyvinylchloride (PVC). The two compartments exhibited centered and square openings 4-in (10.16 cm)×4-in (10.16 cm) for accommodating an anion exchange membrane (AEM). The two compartments were stacked together by means of ½-inch thick aluminum back plates bolted together with four ⅜-inch (9.525 mm) stainless steel grade AISI 316 bolts as tie rods. The gaskets between the stacked compartments were made of 1.8-in thick EPDM sheets. The electrode-to-membrane gap was 0.5 inch (12.7 mm).

The electrochemical setup consisted to a rectangular coupon to be tested as cathode (−) or working electrode (WE) with the following dimensions of 3.75 inches×2.750 inches (95.25 mm×69.85 cm). The cathode polarization was measured against a reference electrode (RE). The reference electrode was a mercury-mercurous sulfate-sulfuric acid type [Hg/Hg₂SO₄/H₂SO₄ (30 wt. %)] from Koslow Scientific Company (Englewood, N.J., USA). The counter electrode (CE) was a mixed metal oxides (MMO) coated titanium anode of the type Ti/Ta₂O₅-IrO₂ grade EMMO-IRO-TI2-LS manufactured by Electrochem Technologies & Materials Inc. (Montreal, Qc, Canada).

The catholyte and anolyte were aqueous solution of sulfuric acid (22 wt. % H₂SO₄) with a mass density of 1,154.8 kg/m³ (20° C.). The circulation of both catholyte and anolyte inside the corresponding compartment was performed using two high performances peristaltic MASTERFLEX® L/S pumps from Cole Parmer, Inc (Montreal, QC, Canada). For reliability, the fluid linear velocity at the cathode surface was matching the velocity encountered in the prototype and pilot electrolyzer. The current was supplied by a DC power supply Model LLS8018 from Lambda Physics capable to impose a cell voltage up to 18 V and deliver an amperage up to 24 A. From the semi-log plots of the cathode overvoltage vs. the decimal logarithm of the cathode current density, it was then possible to identify to linear regions: the first at low cathode current densities and the second at high cathode current densities from which it was possible to determine the Tafel's coefficients. The TABLE 8 lists the Tafel's coefficients for a selection of industrial cathode materials suitable for performing the electrochemical reduction of transition metal oxides while minimizing or preventing the parasitic hydrogen gas evolution reaction.

TABLE 8
Overvoltages, and Tafel's parameters for the hydrogen gas evolution
reaction (HER) for selected cathode materials (22 wt. % H₂SO₄) at 20° C.

| | | | | | | | Electric resistivity | |
|---|---|---|---|---|---|---|---|---|
| | j_{c} = −1,000 A/m² | | | j_{c} = −4,000 A/m² | | | | Temp. |
| | b | a | η_{C} | b | a | η_{C} | Resistivity | coefficient |
| Cathode materials | (V/logj) | (V) | (V) | (V/logj) | (V) | (V) | (μΩ.cm) | (K⁻¹) |
| Niobium (99.9 wt. %) | −0.217 | −0.227 | −0.880 | −0.559 | 0.693 | −1.322 | 15.2 | 0.00263 |
| Duplex LDX2101 | −0.392 | 0.256 | −0.919 | −0.826 | 1.462 | −1.513 | 80.0 | n.a. |
| Zirconium 702 | −0.122 | −0.718 | −1.085 | −0.315 | −0.187 | −1.321 | 39.7 | 0.00440 |
| Zirconium 705 | −0.142 | −0.670 | −1.095 | −0.524 | 0.376 | −1.513 | 55.0 | n.a. |
| Titanium Grade 2 | −0.203 | −0.526 | −1.135 | −0.519 | 0.340 | −1.529 | 56.2 | 0.00380 |
| Titanium Grade 7 | −0.333 | −0.119 | −1.117 | −0.707 | 0.903 | −1.645 | 56.0 | 0.00380 |
| Tantalum (99.9 wt. %) | −0.363 | −0.030 | −1.118 | −0.355 | −0.051 | −1.330 | 12.5 | |
| Graphite (R8710) | −0.593 | 0.517 | −1.261 | −1.684 | 3.476 | −2.592 | 1,375.0 | n.a. |
| Lead (chemical) | −1.121 | 1.135 | −2.229 | −4.801 | 11.203 | −6.090 | 20.6 | 0.00428 |

Close examination the above table, shows that among the several cathode materials, the utilization of lead, dense graphite and in lesser extent refractory metals such as tantalum, zirconium and titanium offers very high hydrogen overvoltages for a medium cathode current density of −1,000 A/m² but this trend becomes even more significant at a high cathode current density of −4,000 A/m². The latter was of great importance for performing the electrolysis at the highest space time yield, thus throughput, compatible with an industrial operation. This is the reason why pure chemical lead was often selected, as it is a cheap metal, it is easily form into intricate shapes, it is an excellent electrical conductor and it is not brittle when compared to graphite. Moreover, pure lead exhibits an excellent corrosion resistance towards sulfuric acid for a wide range of concentration. However, for very abrasive suspensions such as those with a high pulp density and/or containing for instance large particles of titanium dioxide, chromium trioxide, or cerium dioxide, where we have noticed the smearing of the surface of the lead cathode, harder cathode materials such as tantalum, zirconium or titanium can be used instead.

### EXAMPLE 4

The electrochemical reduction of a suspension of chemical grade vanadium pentoxide to produce an equimolar vanadium electrolyte: A batch of 20 liters of equimolar vanadium electrolyte with the targeted molarities of [V(total)]=1.6 M and [H₂SO₄(free)]=2.0 M was prepared directly from chemical grade vanadium pentoxide (99.996 wt. % V₂O₅). The chemical composition and main properties of the vanadium (V) oxide powder that was utilized is reported in TABLE 9. A mass of 2.911 kg of vanadium pentoxide powder “as received” was then added in a single step to 26.31 kg of an aqueous solution of sulfuric acid having a mass percentage of 40.2 wt. % H₂SO₄ and a mass density of 1,304.6 kg/m³ (20° C.) to produce a suspension with a pulp density of 9.96 wt. % solids. During the addition of solids, the catholyte was circulating in loop between the catholyte tank and the cathode compartment of a FLOWPRO III type divided electrolyzer with a steady volume flow rate of 3 gallons per minute (11.36 L/min). Similarly, a sulfuric acid solution having a mass percentage of only 20 wt. % H₂SO₄ with a mass density of 1,139 kg/m³ at 20° C. was circulating at countercurrent inside the anode compartment with the same volume flow rate. Actually, the volume flow rates and the static head inside each tank were kept nearly identical to maintain a low differential pressure between the two compartments in order to minimize the mechanical stresses exerted on the central anion exchange membrane (AEM). Once the suspension was fully homogenized and flowing steadily, the DC power supply was turned on and the current between the electrodes ramped up by 50 A increments to reach a total current of 300 A within 6 minutes. This corresponded to a cathode current density (CCD) of 300 A/ft² (3,229 A/m²). In the first ten minutes of operation, we observed a slight foaming occurring at the surface of the suspension inside the catholyte tank. This foaming ceased rapidly and it was attributed to the slight production of hydrogen gas at the cathode.

From a heat transfer standpoint, due to the intense Joule's heating, the temperatures of the catholyte and anolyte climbed rapidly without any temperature control to 40° C. after only 20 minutes of operation, afterwards the cold water circulation was started inside the two heat exchangers to keep the maximum operating temperature always below 50° C. until completion of the electrolysis. During the electrochemical reduction, the headspace above the catholyte tank was swept with a volume flow rate of 0.050 L/min of pure argon to provide a blanket of inert gas for preventing the air-oxidation of V(III) produced towards the end of the electrolysis.

TABLE 9
Chemical analysis and characteristics of two batches of
vanadium (V) oxide.

| Material | Chemical grade | Technical grade |
|---|---|---|
| (Condition) | (As received) | (Ground flakes) |
| Particle size (Tyler) | −325 mesh (98%) | −200 mesh (95%) |
| | (44 μm) | (75 μm) |
| Tap density (kg/m³) | 2,500 | 2,800 |
| Oxide/Element | Chemical composition (wt. %) | |
| V₂O₅ | 99.960 | 98.215 |
| V₂O₄ | 0.230 | n.a. |
| V(total) | 55.994 | 55.017 |
| As | n.a. | 0.042 |
| Ca | 0.006 | 0.054 |
| Fe | 0.009 | 0.330 |
| Mo | 0.002 | 0.100 |
| S | n.a. | 0.030 |
| K | 0.005 | 0.328 |
| Si | 0.004 | 0.290 |
| Na | 0.001 | 1.137 |

Upon homogenization, the suspension of vanadium pentoxide or slurry exhibited a bright orange color and the measured oxidation redox potential (ORP) was +900 mV/AgCl (+468 mV/MSSA). Soon after a specific electric charge delivered to the catholyte reached 4.0 Ah/kg, the measured ORP was +785 mV/AgCl (+353 mV/MSSA) and the color of the suspension turned kaki indicating that already some V₂O₅ was dissolved with the production of the blue vanadyl cations (VO²⁺) interfering visually with the orange color of the suspended powder. Once a specific electric charge of 15 Ah/kg of catholyte has circulated, the suspension turned to a vivid emerald green with a measured ORP of +620 mV/AgCl (+188 mV/MSSA) indicating an equimolar ratio of peroxovanadium (VO₂⁺) (Canary yellow) and vanadyl (VO²⁺) cations (Blue) yielding the emerald green color observed. Afterwards, for a specific electric charge of 32 Ah/kg the catholyte became a clear solution without any solid particles suspended and it exhibited a deep celestial blue color indicating that all the vanadium was now present as vanadyl cations (VO²⁺). Finally, after a specific electric charge of 48 Ah/kg has been delivered, the solution exhibited a greenish blue color with a measured ORP of +100 mV/AgCl (−332 mV/MSSA).

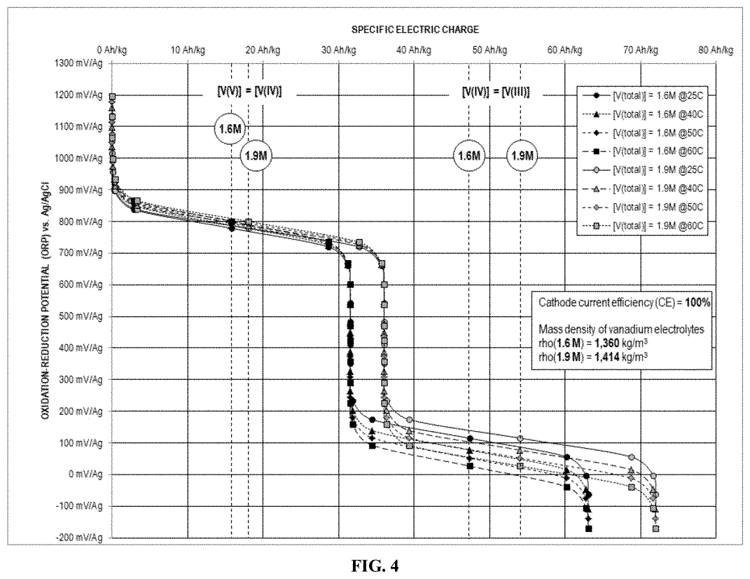

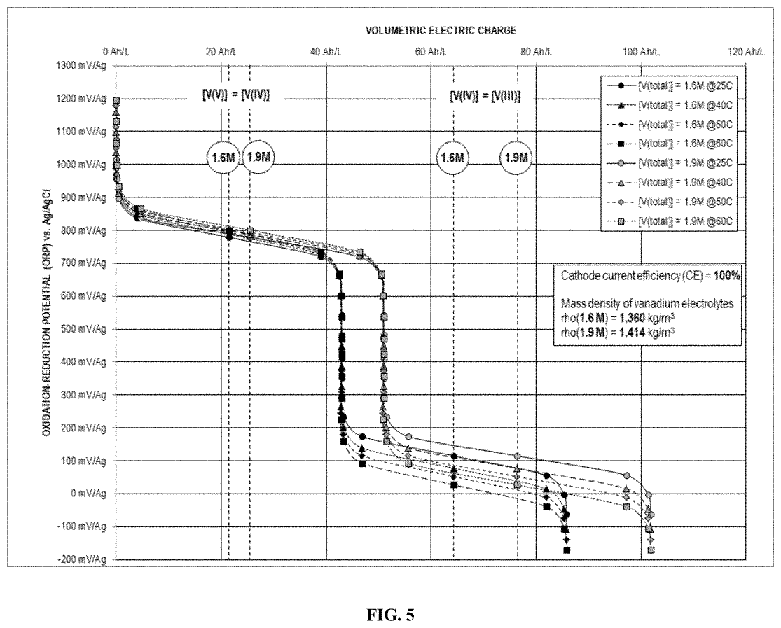

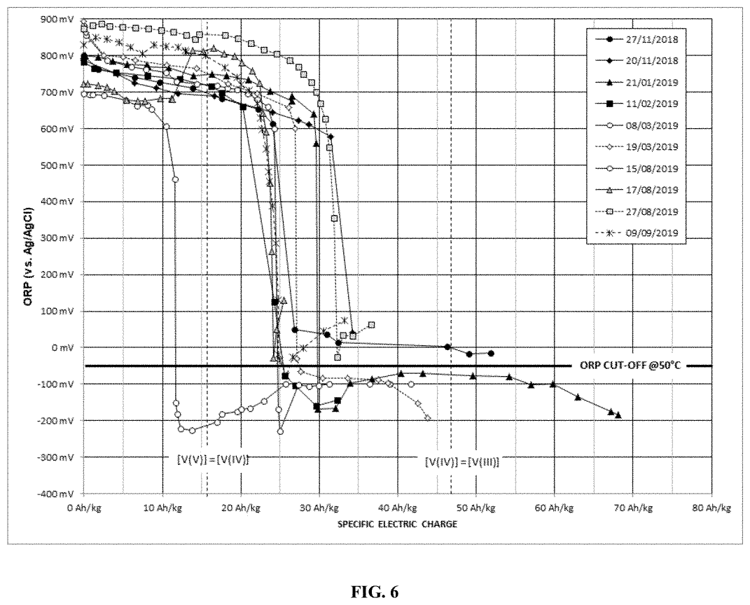

The plot of the oxidation-reduction potential (ORP) measured vs. the actual electric charge supplied to the catholyte exhibits the same “S” shape for potentiometric redox titration curves. For instance, the FIG. 4 and FIG. 5 described the theoretical plots of the calculated ORP vs. the specific (resp. volumetric) electric charge for a vanadium molarity of 1.6 M and 1.9 M respectively showing the particular “S” shape while FIG. 6 gathers several actual plots recorded during the preparation of several batches of all vanadium sulfate electrolytes according to the present disclosure.

During electrolysis, the overall cell voltage decreased from 9.7 volts at the beginning when both electrolytes were at ambient temperature down to 7.0 volts with an averaged value of 8.0V at 50° C. This decrease in cell voltage can be explained by: (1) the increasing operating temperature that enhanced the ionic conductivities of both electrolytes; (2) the increasing concentration of sulfuric acid in the anode compartment which also increases the conductivity of the anolyte.

After 4 hours and 20 minutes (260 minutes) of non-stop electrolysis, the vanadium electrolyte was allowed to cool down to room temperature and was filtered through the strainer and drained from the catholyte tank directly into 5-gallons PP drum filled with argon gas for preventing the air oxidation of V(III) during storage. Actually, if air is left inside the drum headspace, over time the oxygen is absorbed by reaction with V(III) and we observed the shrinking of the drum walls due to the reduced pressure existing inside. Afterwards, the molarities of the vanadium species was determined by potentiometric redox titration using cerium (IV) as oxidizing reagent and UV-Visible spectrophotometric analysis. The mass percentage of free sulfuric acid was determined by gas volumetric analysis using a precision gas burette with a mass percentage of 14.87 wt. H₂SO₄. For the accurate determination of the traces of chemical elements, samples were analyzed by ICP-MS by an external laboratory. An example of the composition of the vanadium electrolyte produced from chemical grade vanadium pentoxide according to the experimental conditions above is reported in TABLE 10.

TABLE 10
Chemical analysis and properties at 20° C. of the vanadium
electrolytes produced.

| Vanadium electrolyte prepared | | | Vanadium electrolyte prepared | | |
|---|---|---|---|---|---|
| from chemical grade V₂O₅ | | | from technical grade V₂O₅ | | |
| Color | Greenish blue | | Color | Greenish blue | |
| ORP vs. Ag/AgCl | +118 mV | | ORP vs. Ag/AgCl | +123 mV | |
| Mass density | 1,356 kg/m³ | | Mass density | 1,414 kg/m³ | |
| Conductivity | 254 mS/cm | | Conductivity | 245 mS/cm | |
| [V(total)] | 1.576M | | [V(total)] | 1.873M | |
| [V(IV)] | 0.785M | | [V(IV)] | 0.952M | |
| [V(III)] | 0.791M | | [V(III)] | 0.921M | |
| [H₂SO₄(free)] | 2.056M | | [H₂SO₄(free)] | 2.098M | |
| V | 80,284 | mg/L | V | 95,413 | mg/L |
| Al | 14 | mg/L | Al | 107 | mg/L |
| As | l | mg/L | As | 5 | mg/L |
| Ca | 23 | mg/L | Ca | 50 | mg/L |
| Co | l | mg/L | Co | 2 | mg/L |
| Cr | 4 | mg/L | Cr | 6 | mg/L |
| Cu | l | mg/L | Cu | 2 | mg/L |
| Fe | 33 | mg/L | Fe | 110 | mg/L |
| K | 50 | mg/L | K | 185 | mg/L |
| Mg | 28 | mg/L | Mg | 17 | mg/L |
| Mn | 4 | mg/L | Mn | 8 | mg/L |
| Mo | l | mg/L | Mo | 54 | mg/L |
| Na | 48 | mg/L | Na | 207 | mg/L |
| Ni | 12 | mg/L | Ni | 17 | mg/L |
| Pb | 3 | mg/L | Pb | l | mg/L |
| Si | 23 | mg/L | Si | 105 | mg/L |

We can see from the above table that the major impurities are the alkali-metals potassium, and sodium, followed by iron, magnesium, calcium, silica, and alumina with concentration ranging only from 10 mg/L to 50 mg/L. The low concentration of lead confirmed the excellent stability of pure “corroding” lead as cathode material as expected.

From the actual molarities of the two vanadium species with [V(IV)]=0.785 M and [V(III)]=0.791 M, it was possible to calculate the theoretical volumetric electric charges of the equimolar catholyte according to:

qᵥ(Ah/dm³)={[V(IV)]+2[V(III)]}F(Ah/mol)

Based on its numerical value of 63.44 Ah/L, it was then possible to calculate cathode current efficiency (CCE) as defined earlier. Based on a volume of catholyte produced equal to 20 liters, the theoretical electric charge required was 1,269 Ah. On the other hand, the actual electric charge supplied was 300A×(260/60) hours =1,300 Ah. Therefore, the cathode current efficiency was 97.6 percent.

Secondly, we calculated the electrochemical conversion yield (ECY) according to the practical equation.

ECY(%)=100(M_{V2O5}/2)·[V(total)]V_{SOLN}/(w_{V2O5}m_{V2O5})

ECY(%)=9,094[V(total)]V_{SOLN}/(w_{V2O5}m_{V2O5})

Based on a volume of solution of 20L, a mass of 2,911 grams of vanadium pentoxide with a purity of 99.96 V₂O₅% that was used, and a total molarity of vanadium of 1.576 M, the electrochemical conversion yield obtained was 98.5 percent. At this point, it is important to point out that the discrepancy between the CCE and ECY is normal as the former ratio is calculated based on the speciation of the vanadium while the latter ratio is calculated based on the total vanadium.

The specific energy consumption per unit mass of electrolyte was calculated using the average cell voltage as 8.0 V×1300 Ah/(20 dm³×1.356 kg/dm³), that is, 0.383 kWh/kg, and the volumetric energy consumption was 8.0 V×1300 Ah/20 dm³, that is, 0.520 kWh/dm³.

### EXAMPLE 5

The electrochemical reduction of a suspension of technical grade vanadium pentoxide to produce a concentrated equimolar vanadium electrolyte: A batch of 20 liters of equimolar vanadium electrolyte with the targeted molarities of [V(total)]=1.9 M and [H₂SO₄(free)]=2.0 M was prepared directly from technical grade vanadium pentoxide (98.215 wt. % V₂O₅). The chemical composition and main characteristics of the technical grade vanadium (V) oxide powder that was utilized is reported in TABLE 9. A mass of 3.460 kg of vanadium pentoxide powder chemical grade was then added in a single step to 27.26 kg of an aqueous solution of sulfuric acid having a mass percentage of 43.3 wt. % H₂SO₄ and a mass density of 1,321 kg/m³ (20° C.) to produce a suspension with a pulp density of 11.3 wt. % solids.

The experimental setup and the operating conditions were identical to those described in the example 4 except, the total current that was 280 A instead corresponding to a cathode current density (CCD) of 280 A/ft² (3,014 A/m²). The electrolysis was conducted during 5 hours and 30 minutes (330 minutes) with an average voltage of 7.8V. The molarities of [V(IV)] and [V(III)] were determined by potentiometric redox titration using cerium (IV) as oxidizing reagent and verified by UV-visible spectrophotometry analysis. The mass percentage of free sulfuric acid was determined by gas volumetric analysis using a precision gas burette with a mass percentage of 14.55 wt. H₂SO₄. The chemical composition and properties of the equimolar vanadium electrolyte obtained is reported TABLE 10.

Close examination of the chemical composition of the vanadium electrolyte produced by ICP-MS reveals as expected that the concentration of impurities using the technical grade is higher than with the chemical grade. These are the alkali-metals potassium, and sodium followed by iron, aluminum and silica, with concentrations ranging from 100 mg/L to 200 mg/L with minor concentration of calcium and molybdenum. Again, the low concentration of lead confirmed the excellent stability of pure “corroding” lead as cathode material.

In this experiment, the actual electric charge supplied was: 280A×(330/60) hours=1,540 Ah. The theoretical volumetric electric charge based on the chemical composition of the vanadium electrolyte with [V(IV)]=0.952 M and [V(III)]=0.921 M was 74.88 Ah/L. Thus with a total volume of 20 L, the theoretical electric charge required was 1,498 Ah. Therefore, the cathode current efficiency was 97.2 percent and the electrochemical conversion yield obtained was 98.4 percent. On the other hand, the specific energy consumption per unit mass of electrolyte produced was 7.8 V×1540 Ah/(20 L×1.354 kg/dm³), that is, 0.444 kWh/kg and the volumetric energy consumption was 0.601 kWh/dm³.

### Example 6

The electrochemical reduction of a suspension of chemical grade vanadium pentoxide to produce a concentrated solution of vanadyl sulfate: A batch of 20 liters of a concentrated solution of vanadium (IV) sulfate or vanadyle sulfate with the targeted molarities of [V(IV)]=3.0 M and [H₂SO₄(free)]=1.0 M was prepared directly from chemical grade vanadium pentoxide. The chemical composition and main characteristics of the chemical grade vanadium (V) oxide powder that was utilized is reported in TABLE 9. A mass of 5.460 kg of vanadium pentoxide powder chemical grade was then added in a single step to 24.39 kg of an aqueous solution of sulfuric acid having a mass percentage of 33.3 wt. % H₂SO₄ and a mass density of 1,246 kg/m³ (20° C.) to produce a suspension with a pulp density of 18.3 wt. % solids.

The experimental setup and the operating conditions were identical to those described in the examples 4 and 5 except, the total current intensity that was 310 A instead corresponding to a cathode current density (CCD) of 310 A/ft² (3,337 A/m²). The electrolysis was conducted during 5 hours and 15 minutes (315 minutes). The average voltage was 7.1V. The mass percentage of free sulfuric acid was determined by gas volumetric analysis using a precision gas burette with a mass percentage of 7.37 wt. H₂SO₄. The chemical composition and properties of the concentrated solution of vanadyl sulfate obtained is reported TABLE 11. Close examination of the chemical composition of the vanadyl sulfate solution produced reveals that the major impurities are the alkali-metals potassium, and sodium followed by iron, aluminum and silica, with concentrations ranging from 10 mg/L to 65 mg/L. As for the previous examples 4 and 5, the low concentration of lead confirmed the excellent stability of pure “corroding” lead as cathode material.

TABLE 11
Chemical analysis and characteristics of the concentrated solution of
vanadyle sulfate produced.
Concentrated solution of vanadyle sulfate

| Color | Deep blue | |
|---|---|---|
| ORP vs. Ag/AgCl | +280 mV | |
| Mass density | 1,470 kg/m³ | |
| Electrical conductivity | 180 mS/cm | |
| [V(total)] | 2.971M | |
| [V(IV)] | 2.966M | |
| [V(III)] | 0.005M | |
| [H₂SO₄(free)] | 1.104M | |
| V | 151,347 | mg/L |
| Al | 9 | mg/L |
| As | l | mg/L |
| Ca | 19 | mg/L |
| Co | l | mg/L |
| Cr | 3 | mg/L |
| Cu | 1 | mg/L |
| Fe | 24 | mg/L |
| K | 62 | mg/L |
| Mg | 23 | mg/L |
| Mn | 2 | mg/L |
| Mo | l | mg/L |
| Na | 52 | mg/L |
| Ni | 9 | mg/L |
| Pb | 1 | mg/L |
| Si | 19 | mg/L |

In this experiment, the actual electric charge supplied was:

$$310 A \times ( 315 / 60 ) hours = 1.628 Ah .$$

The theoretical volumetric electric charge based on the chemical composition of the solution of vanadyle sulfate with [V(IV)]=2.966 M and [V(III)]=0.005 M of [V(III)] was 79.8 Ah/L. Thus with a total volume of 20 L, the theoretical electric charge required was 1,595 Ah. Therefore, the cathode current efficiency was 97.9 percent and the electrochemical conversion yield obtained was 99.0 percent. Moreover, the specific energy consumption per unit mass of electrolyte was

$$7.1 V \times 1.628 Ah / ( 20 L \times 1.47 kg / {dm}^{3} ) ,$$

that is, 0.393 kWh/kg and the volumetric energy consumption was 0.578 kWh/dm³.

A summary gathering all the experimental results and performances obtained in examples 4, 5 and 6 is reported TABLE 12 hereafter.

TABLE 12
Comparison of the results and performances obtained for examples 4, 5 and 6.

| | Example 4- | Example 5- | Example 6- |
|---|---|---|---|
| | Vanadium | Vanadium | Concentrated |
| | electrolyte from | electrolyte from | solution of vanadyl |
| Parameters and properties (units) | chemical grade | technical grade | sulfate |
| Color | Greenish blue | Greenish blue | Deep celestial blue |
| ORP (mV vs. Ag/AgCl) | +118 | +123 | +280 |
| [V(total)] (mol/L) | 1.576 | 1.873 | 2.971 |
| [V(IV)] (mol/L) | 0.785 | 0.952 | 2.966 |
| [V(III)] (mol/L) | 0.791 | 0.921 | 0.005 |
| [H₂SO₄(free)] (mol/L) | 2.056 | 2.098 | 1.104 |
| Mass density (kg/m³) | 1,356 | 1,414 | 1,470 |
| Electrical conductivity (mS/cm) | 254 | 245 | 180 |
| Cathode current density (A/m²) | 3,229 | 3,014 | 3,337 |
| Averaged overall cell voltage (V) | 8.0 | 7.8 | 7.1 |
| Specific electric charge (Ah/kg) | 47.9 | 54.5 | 55.4 |
| Volumetric electric charge (Ah/L) | 65.0 | 77.0 | 81.4 |
| Cathode current efficiency (CCE) | 96.7 | 97.2 | 97.9 |
| Electrochemical conversion yield (ECY) | 98.5 | 98.4 | 99.0 |
| Specific energy consumption (kWh/kg) | 0.383 | 0.444 | 0.393 |
| Volumetric energy consumption (kWh/L) | 0.520 | 0.601 | 0.578 |
| Volumetric space time yield (L/m²/h) | 48.0 | 38.0 | 40.1 |

### EXAMPLE 7

The electrochemical reduction of a suspension of pure hematite to produce a concentrated solution of ferrous sulfate: A batch of 2.5 liters of a concentrated solution of ferrous sulfate with a targeted molarities of [Fe(II)]=1.55 M and [H₂SO₄(free)]=0.55 M was prepared directly from pure iron (III) oxide (hematite) supplied from Alfa-Aesar (Product No.: 12375, Lot No.: M29F007). The chemical composition and main characteristics of the pure hematite powder that was utilized is reported in TABLE 13. A mass of 315.7 grams of hematite powder was then added in a single step to 2.581 kg of an aqueous solution of sulfuric acid having a mass percentage of 20.4 wt. % H₂SO₄ and a mass density of 1,143 kg/m³ (20° C.) to produce a suspension with a pulp density of 10.9 wt. % solids. As for the previous examples, during the addition of solids, the catholyte was always circulating.

The experimental setup consisted to utilize a PROTOTYPE II divided electrolyzer manufactured by Electrochem Technologies & Materials Inc. (Montreal, QC, Canada) with open tops for accessing and inspecting each compartments from above, for removing electrodes, and visually checking the color of the suspension and possible gases evolution. The electrolyzer accommodated a set of 10-inch×9-inch rectangular lead cathode and titanium coated with mixed metal oxides (MMO) as anode with a central anion exchange membrane (AEM). The PROTOTYPE II was operated without any storage tanks thus the catholyte and anolyte circulated simply in closed loops directly through the cathode and anode compartment respectively. A steady volume flow rate of 3 gallons per minute (11.36 L/min) was used for both the anolyte and catholyte. The anolyte was a sulfuric acid solution having a mass percentage of only 20 wt. % H₂SO₄ with a mass density of 1,139 kg/m³ at 20° C. circulating at countercurrent inside the anode compartment. Except for the above setup modification, operating conditions were identical to those described in the examples 4, 5, and 6 and the total current intensity that was 80 A corresponding to a cathode current density (CCD) of 128 A/ft² (1,378 A/m²). The electrolysis was conducted during 1 hour and 20 minutes (80 minutes). The average voltage was 4.0 V. Visually, the color of the suspension was initially red blood and then turned to dark green then pale green at the end of the electrolysis.

TABLE 13
Chemical analysis and properties of the iron (III) oxide (hematite).

| Material | Iron (III) oxide | |
|---|---|---|
| (Condition) | As received | |
| Particle size (Tyler) | −325 mesh | |
| Tap density (kg/m³) | 3,300 | |
| Fe₂O₃ | 98 | wt. % |
| Moisture | 0.29 | wt. % |
| Ca | 100 | mg/kg |
| Mg | 100 | mg/kg |
| Na | 186 | mg/kg |
| K | 100 | mg/kg |
| Zn | 103 | mg/kg |
| Cu | 65 | mg/kg |
| Al | 627 | mg/kg |
| Ti | 16 | mg/kg |
| V | 32 | mg/kg |

The mass density of the solution at 20° C. was 1,170 kg/m³ when measured with a Mohr-Westphal hydrostatic balance. The chemical analysis of the final solution of ferrous sulfate was performed by potentiometric redox titration using cerium (IV) as oxidizing reagent and the free sulfuric acid was measured by volumetric gas analysis. The final molarity of iron (II) was then [Fe(II)]=1.532 M with only [Fe(III)]=0.002 M and the mass percentage of the free sulfuric was 4.4 wt. H₂SO₄. The solution was stored in a 2.5L-jug with filled with argon to avoid air-oxidation of the Fe (II).

In this experiment, the actual electric charge supplied was: 80A×(80/60) hours=106.7 Ah. The theoretical volumetric electric charge based on the chemical composition of the solution of ferrous sulfate with the previous molarities [Fe(II)]=1.532 M with [Fe(III)]=0.002 M was 41.1 Ah/L. Thus with a total volume of 2.5 L, the theoretical electric charge required was 102.6 Ah. Therefore, the cathode current efficiency was 96.2 percent and the electrochemical conversion yield obtained was 99.0 percent. Moreover, the specific energy consumption per unit mass of solution was 4.0 V×106.7 Ah/(2.5×1.170 kg/dm³), that is, 0.146 kWh/kg and the volumetric energy consumption was 0.171 kWh/dm³.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

1. An electrochemical process for producing aqueous solutions of transition metal sulfates from the corresponding transition metal oxides, the process comprising:
Preparing a suspension by mixing transition metal oxides with sulfuric acid as a carrier fluid; and
Reducing electrochemically the suspension of transition metal oxides by circulating the slurry inside the cathode compartment of an electrolyzer producing a solution of transition metal sulfates; and
Producing concurrently, inside the anode compartment, oxidizing co-products made of: sulfuric acid, oxygen gas, peroxosulfuric acid, ammonium peroxodisulfate, ceric sulfate, manganese dioxide, vanadium pentoxide or other oxidizing inorganic product.

2. The process of claim 1, wherein the transition metal oxides have the empirical chemical formula M₂Oₓ with x being an integer ranging from x equal to 1 to x equal to 7 and M a transition metal with M=Ti, V, Cr, Mn, Fe, Co, Ni, Cu, Ce, Pr, Eu, Tb, U, Np, and Pu.

3. The process of claim 2, wherein the transition metal oxides comprise oxides of titanium, oxides of vanadium, oxides of chromium, oxides of manganese, oxides of iron, oxides of cobalt, oxides of nickel, oxides of copper, oxides of cerium, oxides of praseodymium, oxides of europium, oxides of terbium, oxides of uranium, oxides of neptunium, and oxides of plutonium, or a mixture thereof.

4. The process of any one of claims 1 to 3, wherein the transition metal oxides are mixed with sulfuric acid as carrier fluid to obtain a suspension of the solids or slurry.

5. The process of any one of claims 1 to 4, wherein the sulfuric acid has a mass percentage from about 5 wt. % H₂SO₄ to about 98 wt. % H₂SO₄.

6. The process of claim 5, wherein the aqueous solution of sulfuric acid has a mass percentage from about 10 wt. % H₂SO₄ to about 80 wt. % H₂SO₄.

7. The process of claim 5 or 6, wherein the aqueous solution of sulfuric acid has a mass percentage from about 15 wt. % H₂SO₄ to about 60 wt. % H₂SO₄.

8. The process of any one of claims 1 to 7, wherein the mass percentage of suspended solids or pulp density ranges from 1 wt. % solids up to 80 wt. % solids.

9. The process of claim 8, wherein the pulp density ranges from 5 wt. % solids up to 70 wt. % solids.

10. The process of claim 8 or 9, wherein the pulp density ranges from 10 wt. % solids up to 60 wt. % solids

11. The process of any one of claims 1 to 10, wherein the transition metal oxides exhibit a particle size of less than about 0.500 mm.

12. The process of claim 11, wherein the transition metal oxides exhibit a particle size of less than about 0.125 mm.

13. The process of claim 11 or 12, wherein the transition metal oxides exhibit a particle size of less than about 0.050 mm.

14. The process of any one of claims 1 to 13, wherein the suspension of the transition metal oxides with sulfuric acid, is reduced electrochemically inside the cathode compartment of a divided electrolyzer with a separator.

15. The process of any one of claims 1 to 14, wherein the dimensionless ratio of the fluid linear velocity, u_{f}, inside the cathode compartment to the terminal settling velocity, uₜ, calculated for the largest particle, denoted (u_{f}/uₜ), ranges between 1 and 100.

16. The process of any one of claims 1 to 15, wherein the dimensionless ratio of the fluid linear velocity, u_{f}, inside the piping to the terminal settling velocity of the largest particle, uₜ, in the suspension, denoted (u_{f}/uₜ), ranges between 2.0 and 10,000.

17. The process of any one of claims 1 to 16, wherein the cathode is made of aluminum and its alloys, iron and its alloys, cobalt and its alloys, nickel and its alloys, copper and its alloys, cadmium and its alloys, lead or its alloys, zinc and its alloys, titanium and its alloys, zirconium and its alloys, hafnium and its alloys, niobium and its alloys, tantalum and its alloys, mercury and amalgams of mercury, graphite, or electrically conductive ceramics with the spinel structure with chemical formula A^{II}B^{III}₂O₄ where A=Fe²⁺, Co²⁺, Ni²⁺, Mg²⁺, Cu²⁺, and B=Fe³⁺, Al³⁺, Cr³⁺, Ti⁴⁺, V³⁺, such as cast magnetite or nonstoichiometric titanium oxides made of Magneli's phases (e.g., TiₙO₂ₙ₋₁).

18. The process of any one of claims 1 to 17, wherein the anode is made of titanium or titanium alloy coated with mixed metal oxides (MMO), niobium or niobium alloys coated with mixed metal oxides (MMO), tantalum and tantalum alloys coated with mixed metal oxides (MMO), lead and its alloys, lead dioxide, or electrically conductive ceramics with the spinel structure with chemical formula A^{II}B^{III}₂O₄ where A=Fe²⁺, Co²⁺, Ni²⁺, Mg²⁺, Cu²⁺, and B=Fe³⁺, Al³⁺, Cr³⁺, Ti V³⁺, such as cast magnetite or nonstoichiometric titanium oxides made of Magneli's phases (e.g., TiₙO₂ₙ₋₁).

19. The process of any one of claims 1 to 18, wherein the separator is made of a diaphragm or an anion exchange membrane.

20. The process of any one of claims 1 to 19, wherein the anolyte circulating inside the anode compartment is made of: a solution of sulfuric acid (H₂SO₄), a solution of ammonium sulfate [(NH₄)₂SO₄], a solution of cerium (III) sulfate [Ce₂(SO₄)₃], a solution of manganese (II) sulfate (MnSO₄), a solution of iron(II) sulfate (FeSO₄), or a solution of chromium (III) sulfate [Cr₂(SO₄)₃], a spent solution of vanadyle sulfate (VOSO₄), a spent vanadium electrolyte solution, or their mixtures thereof.

21. The process of any one of claims 1 to 20, wherein a co-product is produced in the anode compartment comprising a concentrated solution of sulfuric acid (H₂SO₄), pure oxygen gas, a solution of peroxodisulfuric acid (H₂S₂O₈), a solution of ammonium peroxodisulfate [(NH₄)₂S₂O₈], a solution of cerium (IV) sulfate [Ce(SO₄)₂], electrolytic manganese (IV) oxide (MnO₂), a solution of iron (III) sulfate [Fe₂(SO₄)₃], a solution of chromic acid [H₂CrO₄] or a suspension of vanadium (V) oxide, or their mixtures thereof.

22. The process of any one of claims 1 to 21, wherein the electrochemical reduction is performed at a cathode current density (CCD) from −100 A/m² to −10,000 A/m².

23. The process of claim 22, wherein the electrochemical reduction is performed at a cathode current density (CCD) from −1,000 A/m² to −5,000 A/m².

24. The process of any one of claims 1 to 23, wherein the electrochemical reduction is performed at an operating temperature from 5° C. to 90° C.

25. The process of claim 24, wherein the electrochemical reduction is performed at an operating temperature from 10° C. to 80° C.

26. The process of any one of claims 1 to 25, wherein the catholyte circulates inside the cathode compartment with a linear velocity at the cathode surface from one centimeter per second to 100 centimeters per second.
